(19) United States
(12) Patent Application Publication
(10) Pub. No.: US 2025/0256656 A1
(43) Pub. Date: Aug. 14, 2025

(54) VEHICLE PORT AND RELATED MECHANISMS

(71) Applicant: Rivian IP Holdings, LLC, Irvine, CA (US)

(72) Inventors: Austin Lee Frederickson, Carlsbad, CA (US); Micheal Richard Castiglione, Carlsbad, CA (US); Michal Jan Holcer, Mission Viejo, CA (US); Steve Gillette, Irvine, CA (US); Daniel Geoffrey Walker, Laguna Niguel, CA (US); Nathan Eino Heronen, San Juan Capistrano, CA (US); Mohamad Jeffery Hammoud, Bloomfield Hills, MI (US); Jonathan David Salerno, Newport, CA (US)

(73) Assignee: Rivian IP Holdings, LLC, Irvine, CA (US)

(21) Appl. No.: 19/052,940

(22) Filed: Feb. 13, 2025

Related U.S. Application Data
(60) Provisional application No. 63/553,377, filed on Feb. 14, 2024.

(51) Int. Cl. B60R 9/06; B60R 11/00

(52) U.S. Cl. CPC B60R 9/065; B60R 11/00; B60R 2011/004; B60R 2011/005

(57) ABSTRACT

An apparatus can include a structural support attachment. The structural support attachment can couple with a vehicle. The structural support attachment can engage with a body. The body can include a lever to couple the body with the structural support attachment to support a tray external to the vehicle.

### CROSS-REFERENCE TO RELATED PATENT APPLICATIONS

This application claims the benefit of and priority to U.S. Provisional Patent Application No. 63/553,377, filed on Feb. 14, 2024, the entirety of which is incorporated by reference herein.

### INTRODUCTION

Vehicles can carry or transport equipment.

### SUMMARY

This disclosure is generally related to one or more components of a vehicle. The components can include at least one apparatus. The apparatus can include at least one of a structural support attachment or an attachment mechanism. The structural support attachment can include a bumper port. The components can be included with the vehicle. The structural support attachment can be disposed, located, or placed within the vehicle. For example, the structural support attachment can be located in a bumper or bumper plate of the vehicle. As another example, the structural support attachment can be coupled or attached to a chassis of the vehicle. The attachment mechanism can include a body. The attachment mechanism can include a bumper port attachment or a bumper port attachment mechanism.

At least one aspect is directed to an apparatus. The apparatus can include a structural support attachment. The structural support attachment can couple with a vehicle. The structural support attachment can engage with a body. The body can include a lever to couple the body with the structural support attachment to support a tray external to the vehicle.

At least one aspect is directed to a vehicle. The vehicle can include a structural support attachment. The structural support attachment can couple with the vehicle. The structural support attachment can engage with a body. The body can include a lever to couple the body with the structural support attachment to support a tray external to the vehicle.

At least one aspect is directed to a method. The method can include disposing a structural support attachment withing a portion of a vehicle. The structural support attachment can couple with the vehicle. The structural support attachment can engage with a body. The body can include a lever to couple the body with the structural support attachment to support a tray external to the vehicle.

At least one aspect is directed to a vehicle. The vehicle can include a bumper port. The bumper port can receive a bumper port attachment to couple the bumper port attachment with the vehicle. The bumper port attachment can support an object external to the vehicle with the bumper port attachment coupled with the vehicle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with an implementation.

FIG. 2 depicts a perspective view of an apparatus, in accordance with an implementation.

FIG. 3 depicts a perspective view of an attachment mechanism, in accordance with an implementation.

FIG. 4 depicts a cross-sectional view of the attachment mechanism illustrated in FIG. 3, in accordance with an implementation.

FIG. 5 depicts a cross-sectional view of the attachment mechanism illustrated in FIG. 3, in accordance with an implementation.

FIG. 6 depicts a perspective view of the apparatus illustrated in FIG. 2 and of the attachment mechanism illustrated in FIG. 3, in accordance with an implementation.

FIG. 7 depicts a perspective view of a vehicle including the apparatus illustrated in FIG. 2, in accordance with an implementation.

FIG. 8 depicts a perspective view of a vehicle including the apparatus illustrated in FIG. 2, in accordance with an implementation.

FIG. 9 depicts a perspective view of a vehicle including the apparatus illustrated in FIG. 2, in accordance with an implementation.

FIG. 10 depicts a perspective view of a vehicle including the apparatus illustrated in FIG. 2, in accordance with an implementation.

FIG. 11 depicts a perspective view of a vehicle including the apparatus illustrated in FIG. 2, in accordance with an implementation.

FIG. 12 depicts a cross-sectional view of a vehicle including the apparatus illustrated in FIG. 2, in accordance with an implementation.

FIG. 13 depicts a cross-sectional view of a vehicle including the apparatus illustrated in FIG. 2, in accordance with an implementation.

FIG. 14 depicts a cross-sectional view of a vehicle including the apparatus illustrated in FIG. 2, in accordance with an implementation.

FIG. 15 depicts a perspective view of the attachment mechanism illustrated in FIG. 3, in accordance with an implementation.

FIG. 16 depicts a perspective view of the attachment mechanism illustrated in FIG. 3, in accordance with an implementation.

FIG. 17 depicts a perspective view of the attachment mechanism illustrated in FIG. 3, in accordance with an implementation.

FIG. 18A depicts a flow diagram of a process of manufacturing an apparatus, in accordance with an implementation.

FIG. 18B depicts a flow diagram of a process of manufacturing an apparatus, in accordance with an implementation.

FIG. 19 depicts a perspective view of a vehicle, in accordance with an implementation.

FIG. 20 depicts a perspective view of a component illustrated in FIG. 19, in accordance with an implementation.

FIG. 21 depicts a perspective view of a component illustrated in FIG. 19, in accordance with an implementation.

FIG. 22 depicts a perspective view of a component illustrated in FIG. 19, in accordance with an implementation.

FIG. 23 depicts a perspective view of a vehicle, in accordance with an implementation.

FIG. 24 depicts a perspective view of a vehicle, in accordance with an implementation.

FIG. 25 depicts a perspective view of a vehicle, in accordance with an implementation.

FIG. 26 depicts a perspective view of a vehicle, in accordance with an implementation.

FIG. 27 depicts a perspective view of a vehicle, in accordance with an implementation.

FIG. 28 depicts a perspective view of a vehicle, in accordance with an implementation.

FIG. 29 depicts a perspective view of a vehicle, in accordance with an implementation.

FIG. 30 depicts a perspective view of a vehicle, in accordance with an implementation.

FIG. 31 depicts a perspective view of a vehicle, in accordance with an implementation.

FIG. 32 depicts a perspective view of a vehicle including the attachment mechanism illustrated in FIG. 3, in accordance with an implementation.

FIG. 33 depicts a perspective view of a vehicle including the attachment mechanism illustrated in FIG. 3, in accordance with an implementation.

FIG. 34 depicts a perspective view of a vehicle including the attachment mechanism illustrated in FIG. 3, in accordance with an implementation.

FIG. 35 depicts a perspective view of a vehicle including the attachment mechanism illustrated in FIG. 3, in accordance with an implementation.

FIG. 36 depicts a perspective view of a vehicle including the attachment mechanism illustrated in FIG. 3, in accordance with an implementation.

FIG. 37 depicts a perspective view of a vehicle including the attachment mechanism illustrated in FIG. 3, in accordance with an implementation.

FIG. 38 depicts a perspective view of a vehicle including the attachment mechanism illustrated in FIG. 3, in accordance with an implementation.

FIG. 39 depicts a perspective view of a vehicle including the attachment mechanism illustrated in FIG. 3, in accordance with an implementation.

FIG. 40 depicts a perspective view of a vehicle including the attachment mechanism illustrated in FIG. 3, in accordance with an implementation.

FIG. 41 depicts a perspective view of a vehicle including the attachment mechanism illustrated in FIG. 3, in accordance with an implementation.

FIG. 42 depicts a perspective view of a vehicle including the attachment mechanism illustrated in FIG. 3, in accordance with an implementation.

FIG. 43 depicts a perspective view of a vehicle including the attachment mechanism illustrated in FIG. 3, in accordance with an implementation.

FIG. 44 depicts a perspective view of a vehicle including the attachment mechanism illustrated in FIG. 3, in accordance with an implementation.

FIG. 45 depicts a perspective of a vehicle including the attachment mechanism illustrated in FIG. 3, in accordance with an implementation.

FIG. 46 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of a bumper port and an attachment mechanism. The various concepts introduced above and discussed in greater detail below may be implemented in any of numerous ways.

The present disclosure is directed to systems and methods of one or more components for a vehicle. The components can include a structural support attachment and an attachment mechanism. The structural support attachment can include a bumper port. The bumper port can be disposed within or otherwise located within a vehicle. For example, the bumper port can be located in a bumper of the vehicle. The components can include an apparatus. The apparatus can include at least one of the structural support attachment or the attachment mechanism. The apparatus can also be provided as one or more separate components for the vehicle.

The attachment mechanism can include a body. The body can include at least one portion. For example, the body can include a first portion and a second portion. At least one portion of the body can protrude or extend beyond a subsequent portion of the body. For example, the body can include a first portion that protrudes beyond a second portion of the body. A protruding portion of the body can be inserted into the structural support attachment. For example, the structural support attachment can include an opening and the protruding portion can be inserted into the opening.

The structural support attachment can receive the attachment mechanism. For example, the attachment mechanism can be inserted into a housing of the structural support attachment.

The apparatus can include a first structural support attachment and a second structural support attachment. The first structural support attachment can be located in a first portion of a vehicle and the second structural support attachment can be located in a second portion. The first structural support attachment can receive a first attachment mechanism and the second structural support attachment can receive a second attachment mechanism.

Vehicles can include hitch receivers that can receive accessory attachment. The other vehicles can have the hitch receiver located in a single portion. For example, the hitch receivers can be located in a middle or a center portion of the vehicle. The location of the hitch receiver in the center portion can result in challenges. For example, the weight of objects supported by the hitch receivers can result in torque being applied as the weight of the objects extend beyond the center portion of the vehicle. This can result in the objects moving or swaying relative to the hitch receiver. The hitch receivers of other vehicles can be coupled with the other vehicles in hard-to-reach areas. For example, the hitch receivers of other vehicles can be coupled with an under carriage or underbody portion of the vehicle. The coupling location of the hitch receivers can create obstacles. The hitch receivers of other vehicles can also include openings and/or apertures to receive a pin. The pin can be lost or misplaced. Without the pin, attachment accessories can be unable to couple with the hitch receivers.

The disclosed solutions have a technical advantage of providing the structural support attachments that can be disposed within a portion of a vehicle. The structural support attachments can be located within a bumper of the vehicle. The location of the structural support attachments can provide unobstructed access to the structural support attachments. For example, the structural support attachments can be accessible without an operator having to access an undercarriage of the vehicle.

Systems and methods of the present technical solution also include providing the attachment mechanism. The attachment mechanism can include a lever. For example, the attachment mechanism can include an over-center lever. The lever can drive a spring-loaded wedge block. The lever can drive the spring-loaded wedge block to apply a load. For example, the lever can drive the spring-loaded wedge block to apply a load to the structural support attachment. Stated otherwise, the spring-loaded wedge block can apply a vertical spreading load to an inside portion of the structural support attachment. The spring-loaded wedge block can provide uniform or repetitive feedback to create a consistent user experience.

Some of the present technical solutions also include the arrangement or placement of the components of the attachment mechanism. For example, the lever can have an over-center arrangement relative to the spring-loaded wedge block. The arrangement of the lever, relative to the spring-loaded wedge block, can prevent force that is applied to a clamping portion of the attachment mechanism from moving or decoupling the attachment mechanism from the structural support attachment. The attachment mechanism can also include spring-loaded pawls that can provide haptic feedback or indications that the attachment mechanism is coupled or attached with the structural support attachment. The attachment mechanism can include tabs to prevent the pawls from moving once the attachment mechanism is coupled with the structural support attachment.

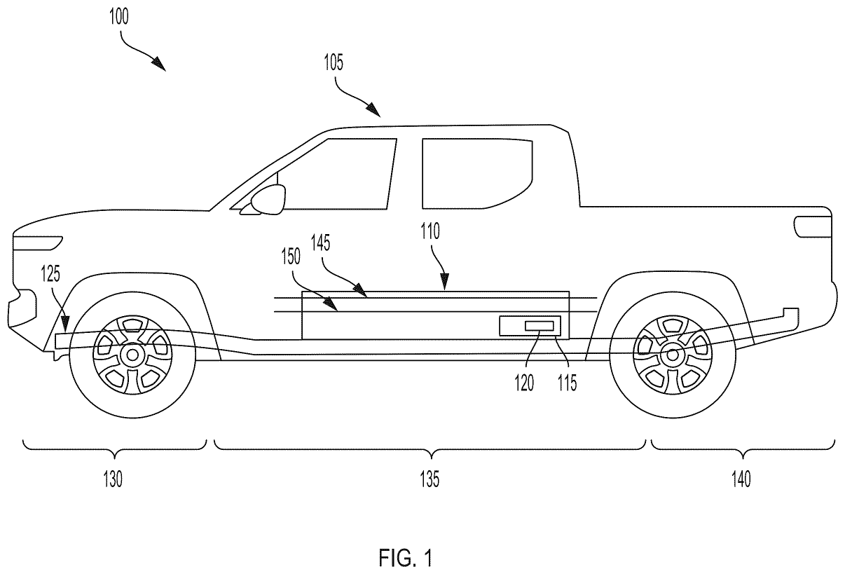

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

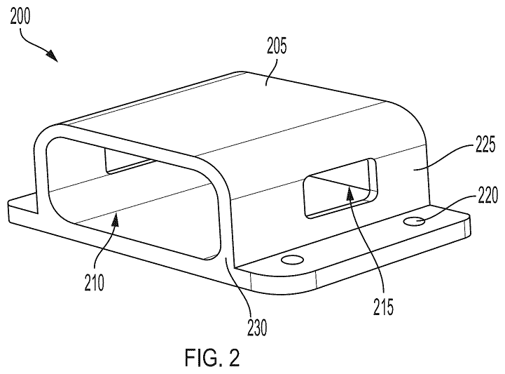

FIG. 2 depicts a perspective view of an apparatus 200. The apparatus 200 can include the apparatus described herein. For example, the apparatus 200 can provide at least one of the technical solutions described herein. The apparatus 200 can be coupled with a vehicle. For example, the apparatus 200 can be coupled with the vehicle 105. The apparatus 200 can be coupled with the vehicle 105 by at least one of attaching, mounting, securing, and/or connecting the apparatus 200 with the vehicle 105. For example, the apparatus 200 can be coupled with the chassis 125 of the vehicle 105.

The apparatus 200 can include at least one structural support attachment 205. The structural support attachment 205 can include the structural support attachment described herein. The structural support attachment 205 can interface with, engage with, or otherwise interact with at least one of the various components described herein. For example, the structural support attachment 205 can engage with the attachment mechanism described herein. The structural support attachment 205 can couple with a vehicle. For example, the structural support attachment 205 can couple with the vehicle 105.

The structural support attachment 205 can include a bumper port 205. The bumper port 205 can be coupled with the vehicle 105. For example, the bumper port 205 can be attached to the vehicle 105 via one or more fasteners. The bumper port 205 can be disposed within a portion of the vehicle 105. For example, the bumper port 205 can be placed or located within a rear bumper of the vehicle 105. Stated otherwise, the bumper port 205 can be disposed within a portion of the vehicle 105 that is located proximate to the rear of the vehicle 105 (e.g., a rear bumper or a rear portion)

The bumper port 205 can include at least one opening 210, at least one aperture 215, at least one slot 220, and at least one housing 230. The opening 210 can define or otherwise establish a body, a housing, or an assembly of the bumper port 205. For example, the opening 210 can define the housing 230. The opening 210 can receive the attachment mechanism described herein. For example, the protruded portion of the attachment mechanism can be inserted into the opening 210. The opening 210 can provide access to the housing 230. For example, the opening 210 can provide a void or a cavity for the body of the attachment mechanism to be inserted into. The opening 210 can position at least a portion of the body within a portion of the vehicle. For example, the opening 210 can position the body of the attachment mechanism within the bumper of the vehicle 105.

The bumper port 205 can engage with the attachment mechanism. For example, the bumper port 205 can engage with the body of the attachment mechanism responsive to the spring-load block wedge applying a load to the bumper port 205. Stated otherwise, the body of the attachment mechanism can connect or interface with the bumper port 205. The housing 230 can include at least one face 225. For example, the housing 230 can include a first face 225 and a second face 225. The faces 225 can include the apertures 215. For example, the first face 225 can include a first aperture 215 and a second face 225 can include a second aperture 215. The apertures 215 can be located or disposed within the faces 225. For example, the apertures 215 can define a gap or a hole within the faces 225.

The apertures 215 can receive at least one of the various components described herein. For example, the apertures 215 can receive the pawls (e.g., a protrusion) described herein. The apertures 215 can provide an opening, a hole, or a gap to allow the pawls to escape or otherwise exist the housing 230 of the bumper port 205. The slots 220 can receive at least one fastener. For example, the slots 220 can receive a bolt or a screw. The slots 220 can couple the bumper port 205 with the vehicle 105 responsive to the slots receiving at least one fastener.

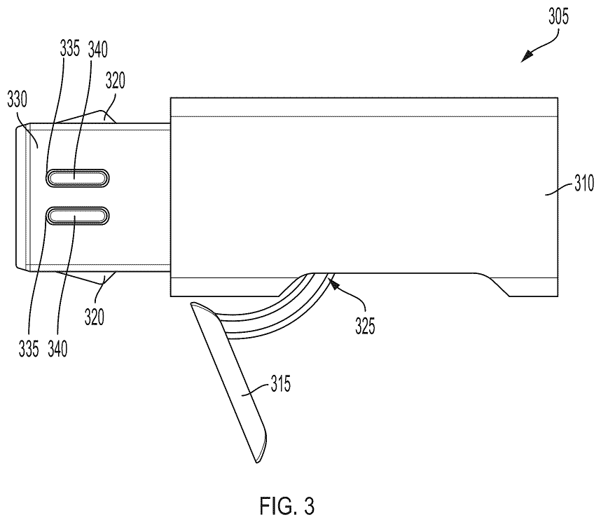

FIG. 3 depicts a perspective view of an attachment mechanism 305. The attachment mechanism 305 can include the attachment mechanism described herein. The attachment mechanism 305 can include the bumper port attachment. The apparatus 200 can include the attachment mechanism 305. The attachment mechanism 305 can include at least on body 310, at least one lever 315, at least one arm 325, at least one pawl 320, at least one portion 330, at least one opening 335, and at least one protrusion 340. The body 310 can include the body described herein. For example, the bumper port 205 can engage with the body 310. The body 310 can include the portion 330. The body 310 or a portion thereof can be inserted into the bumper port 205. For example, the portion 330 can be inserted into the opening 210. The body 310 can include a first portion 330 and a second portion 330. For example, as shown in FIG. 2 the portion 330 protrudes or extends beyond the body 310.

The body 310 can insert within the opening 210. For example, the portion 330 of the attachment mechanism 305 or the body 310 can be placed, located, or otherwise positioned within the opening 210. The body 310 can couple with the bumper port 205 without a rotational force. For example, the body 310 can couple with the bumper port 205 without spinning, twisting, hinging, or otherwise rotating the body 310. The body 310 can couple with the bumper port 205 via a single plane relative to the vehicle. For example, the body 310 can be inserted into the bumper port 205 by applying force within a single plane or direction. The opening 210 can receive at least a portion of the body 310. For example, the body 310 can include the portion 330 and the portion 330 can be inserted into the opening 210 (e.g., the opening 210 receives at least a portion of the body 310).

The lever 315 can couple the body 310 with the bumper port 205. For example, the lever 315 can activate, move, or engage the protrusions 340 to have the protrusions 340 contact the bumper port 205. Stated otherwise the lever 315 can couple the body 310 with the bumper port 205 using the protrusions 340. The body 310 can support a tray that is external to the vehicle 105. For example, the body 310 can support a beam (e.g., a tray) responsive to the lever 315 coupling the body 310 with the bumper port 205. The tray can include at least one of a storage compartment, a tote, a cabinet, a chest, a shelf, a bench, a beam, a board, a cooler, a dresser, a surface top, or other possible storage devices. The lever 315 can be coupled with the arm 325. For example, the lever 315 can be attached, secured, or otherwise mounted to the arm 325.

The lever 315 can include at least one position. For example, the lever 315 can include a first position and a second position. At least one position of the lever 315 can include an unlocked position. FIG. 3 depicts an example of the lever 315 in an unlocked position. At least one position of the lever 315 can include a locked position. The lever 315 can move from a first position to a second position. For example, force can be applied to pivot, swing, twist, rotate, or otherwise adjust a position of the lever 315. The lever 315 can move between positions to reversibly couple the body 310 with the bumper port 205. For example, the body 310 can be coupled with the bumper port 205 with the lever 315 in a first position and the body 310 can be decoupled with the bumper port 205 with the lever 315 in a second position.

The protrusion 340 can be disposed or otherwise located proximate to the opening 335. The protrusion 340 can be coupled with the arm 325. For example, the protrusion 340 can be attached, secured, or mounted to the arm 325. The protrusions 340 can move relative to the arm 325. The protrusions 340 can also move in one or more directions. The protrusions 340 can be indirectly coupled with the arm 325. The lever 315 can control or otherwise move the protrusions 340. For example, the lever 315 can move the protrusions 340 from a first position to a second position. The lever 315 can move the protrusions 340 from a position within the body 310 to a position at least partially external to the body 310. For example, the lever 315 can move the protrusions 340 to cause the protrusions 340 to escape from the body 310 via the openings 335. The protrusions 340 can contact at least a portion of the bumper port 205. For example, the protrusions 340 can contact an internal portion of the housing 230. The protrusions 340 can contact the bumper port 205 with the protrusions 340 in a position that is external to the openings 335. The bumper port 205 can engage with the body 310 responsive to the protrusions 340 making contact with the housing 230.

The pawls 320 can escape the housing 230 via the apertures 215. For example, the pawls 320 can align with and/or otherwise be placed proximate to the apertures 215 responsive to the body 310 or the portion 330 having been inserted into the housing 230. The pawls 320 can secure or lock the body 310 in at least one position. For example, the pawls 320 can secure the body 310 within the housing 230. Stated otherwise, the pawls 320 can secure the portion 330 within the housing 230. The pawls 320 can be coupled with the lever 315. For example, the pawls 320 can be mounted, secured, or attached to the lever 315. The lever 315 can move the pawls 320 from a position within the body 310 to a position that is external to the housing 230 (e.g., the pawls 320 escaped via the apertures 215).

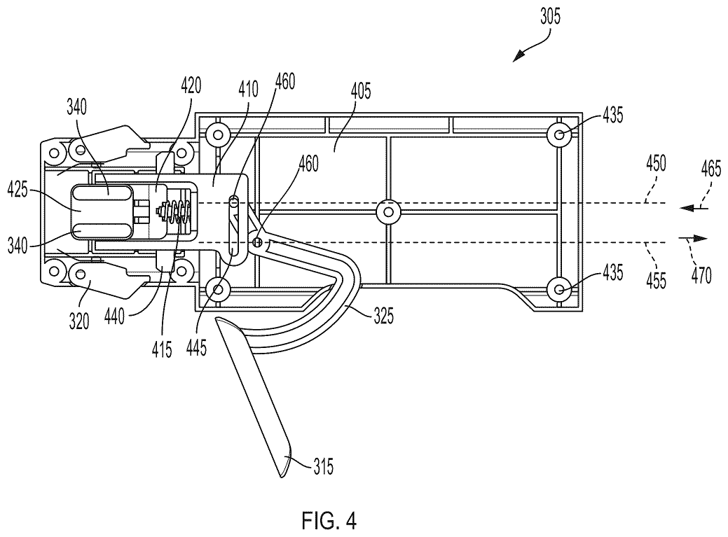

FIG. 4 depicts a cross-sectional view of the attachment mechanism 305. As shown in FIG. 4 a top portion, a top cover, or a top plate of the attachment mechanism 305 has been removed to expose at least one partially internal component of the attachment mechanism 305. The attachment mechanism 305 can include at least one plate 405. For example, the attachment mechanism 305 can include a top plate and a bottom plate 405. The plate 405 can include at least one extrusions. FIG. 4 depicts an example of the attachment mechanism 305 including a bottom plate 405. The bottom plate 405 can include at least one slot 435. The slots 435 can receive at least one fastener to couple or attach the bottom plate 405 with the top plate 405. The plate 405 can also be a bottom portion or segment of an extrusion.

The attachment mechanism 305 can include at least one carriage 410, at least one push block 420, and at least one pressure block 425. At least one of the carriage 410, the push block 420, or the pressure block 425 can refer to or include at least one of the various components described herein. For example, the pressure block 425 can include the wedge block described herein. The carriage 410 can be coupled with the lever 315. For example, the carriage 410 can be indirectly coupled with the lever 315 via the arm 325. The carriage 410 can be movably coupled with the lever 315. For example, the carriage 410 can move along with or as a result of the lever 315 moving. The arm 325 or a portion thereof can move along an opening 445 of the carriage 410. For example, the arm 325 can be coupled with the carriage 410 responsive to a fastener coupling an opening 460 of the arm 325 with the carriage 410.

The arm 325 can include at least one opening 460. For example, the arm 325 can include a first opening 460 and a second opening 460. FIG. 4 depicts an example of the arm 325 including two openings 460. As shown in FIG. 4, a first plane 450 is showing running through the first opening 460 and a second plane 455 is shown running through the second opening 460. As shown in FIG. 4, the first plane 450 is show above the second plane 455. At least one of the first plane 450 or the second plane 455 can define or establish a direction of motion. For example, the first plane 450 can establish motion in at least one of a direction 465 or a direction 470. At least one of the direction 465 or the direction 470 can refer to or include a forward direction. At least one of the direction 465 or the direction 470 can refer to or include a reward direction. At least one of the direction 465 or the direction 470 can refer to or include a first direction. At least one of the direction 465 or the direction 470 can refer to or include a second direction.

The carriage 410 can include at least one spring assembly 415. The spring assembly 415 can include at least one spring and at least one structural member. The spring assembly 415 can be coupled with the push block 420. The spring assembly 415 can move from an expanded position to a compressed position or vice versa. FIG. 4 depicts an example of the spring assembly 415 in an expanded position. The spring assembly 415 can move from the expanded position to a compressed position responsive to the lever 315 moving from a first position to a second position. The spring assembly 415 moving to the compressed position can move the push block 420.

The carriage 410 can include at least one tab 440. The tab 440 can include a member. The tab 440 can also include a push block. The tab 440 can contact or move the pawls 320. For example, the tabs 440 can contact the pawls 320 to move the pawls 320 from a position within the body 310 to a position external to the body 310. As another example, the tabs 440 can prevent the pawls 320 from moving by contacting the pawls 320. The tab 440 can extend in at least one direction beyond a point of the carriage 410. For example, the tabs 440 can extend beyond a body of the carriage 410. FIG. 4 depicts an example of the tabs 440 extending beyond a body of the carriage 410. The tabs 440 can contact the pawls 320 with the spring assembly 415 in a contracted position. The tabs 440 can extend in a first direction beyond a first point of the carriage 410. For example, the tabs 440 can extend laterally (e.g., a first direction) beyond a body or a center of the carriage 410.

The push block 420 can contact or move the pressure block 425. For example, the push block 420 can move the pressure block 425 responsive to the spring assembly 415 moving to the compressed position. The push block 420 contacting the pressure block 425 can cause the pressure block to rise or lift. For example, the pressure block 425 can move from a first height to a second height. The pressure block 425 can include the protrusions 340. The push block 420 moving the pressure block 425 from a first height to a second height can cause the protrusions 340 to escape the openings 335. The body 310 can engage the housing 230 responsive to the push block 420 moving the protrusions from within the body 310 to external the body 310 (e.g., escaped via the openings 335.

The lever 315 can move from an unlocked position, as shown in FIG. 4, to a lock position. The lever 315 moving to a locked position can cause at least one component of the attachment mechanism to move along or in the direction 465. For example, the lever 315 moving to the lock position can cause the carriage 410 to in the direction 465. To continue this example, the carriage 410 moving in the direction 465 can cause the spring assembly 415 to be compressed.

The carriage 410 can move from a first position to a second position. For example, the carriage 410 can move from the position, as shown in FIG. 4, to a second position. The carriage 410 can move from the position shown in FIG. 4 responsive to the lever 315 moving from a first position to a second position.

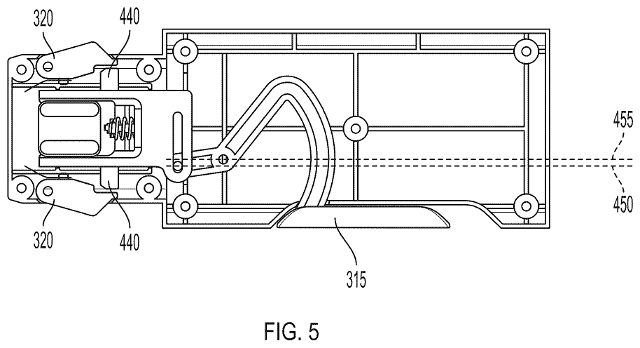

FIG. 5 depicts a cross-sectional view of the attachment mechanism 305. The cross-sectional view, as shown in FIG. 5, can be similar to the cross-sectional view as shown in FIG. 4. FIG. 4 depicts an example of the lever 315 having moved to the locked position or an example of the lever 315 in the locked position. As shown in FIG. 4, the opening 460, the carriage 410, and the push block 420 have moved in the direction 465 responsive to the lever 315 having moved to the locked position.

As shown in FIG. 5, among others, the spring assembly 415 has been compressed responsive to the carriage 410 having moved in the direction 465. The spring assembly 415 being in the compressed position (e.g., compressed) can move the push block 420. The push block 420 can contact the pressure block 425 responsive to the spring assembly 415 being in the compressed position. FIG. 5 depicts an example of the lever 315 as an over-center lever. As shown in FIG. 5, the second plane 455 is shown above the first plane 450. The position of the second plane 455 relative to the second plane 450 is an example of an over-center lever. In this arrangement, the lever 315 is prevented from moving from the locked position (as shown in FIG. 5) to an unlocked position (as shown in FIG. 4) responsive to a force being applied to lever 315 or the arm 325 along or in the direction 470.

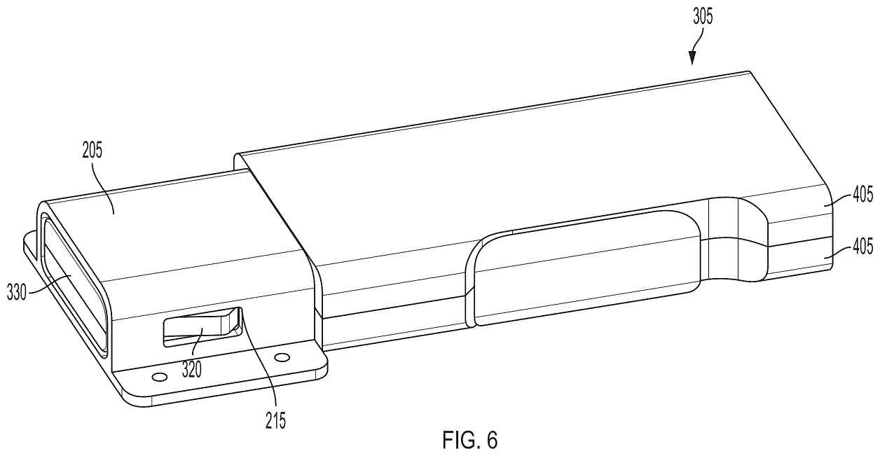

FIG. 6 depicts a perspective view of the bumper port 205 and the attachment mechanism 305. The bumper port 205 can engage with the attachment mechanism 305. For example, the portion 330 can be inserted into the opening 210. FIG. 6 depicts an example of the bumper port 205 engaging the attachment mechanism 305 as the portion 330 is shown inserted into the opening 210. As shown in FIG. 6, the attachment mechanism 305 includes a first plate 405 and a second plate 405. The first plate 405 can be a top plate. The second plate 405 can be a bottom plate. FIG. 6 depicts an example of the tabs 440 having moved the pawls 320 from a position within the body 310 to a position external to the apertures 215. As another example, the pawls 320 can be spring loaded via a spring steel leaf spring. To continue this example, the pawls 320 can be prevented from moving inward (e.g., within the attachment mechanism 305) by the tabs 440.

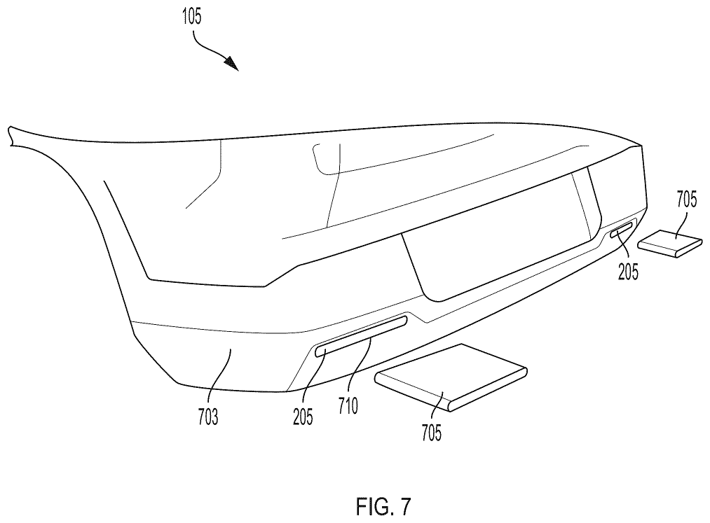

FIG. 7 depicts a perspective view of the vehicle 105. The vehicle 105 can include at least portion 703. The portions 703 can include at one or more various components, locations, or spots of the vehicle 105. The portions 703 can be located proximate to the rear of the vehicle 105. For example, the portions 703 can be located proximate to a rear bumper of the vehicle 105. As another example, the portions 703 can include the chassis 125. The portions 703 can include at least one opening 710. The openings 710 can include a void or a gap for which the bumper port 205 can be accessible. For example, the openings 710 can provide access to the opening 210.

The apparatus 200 can include a first bumper port 205 and a second bumper port 205. The first bumper port 205 can be disposed within a first opening 710. The second bumper port 205 can be disposed within a second opening 710. FIG. 7 depicts an example of a first bumper port 205 disposed within a first opening 710 and an example of a second bumper port 205 disposed within a second opening 710. The first bumper port 205 can support a first portion of a tray. For example, the first bumper port 205 can support a first part of a bike rake (e.g., a tray). As another example, the second bumper port 205 can support a second part of the bike rake. The first bumper port 205 and the second bumper port 205 both supporting a part of the tray can refer to a uniform weight distribution.

The apparatus 200 can include at least one plug 705. The plug 705 can be inserted into the opening 710. The plug 705 can enclose or cover the bumper port 205. For example, the plug 705 can isolate the bumper port 205 from an external environment (e.g., rain, dirt, dust, mud, snow, etc.). The plug 705 can also prevent debris from entering the housing 230. FIG. 7 depicts an example of the plug 705 external to the opening 710 (e.g., the plug is not covering the bumper port 205).

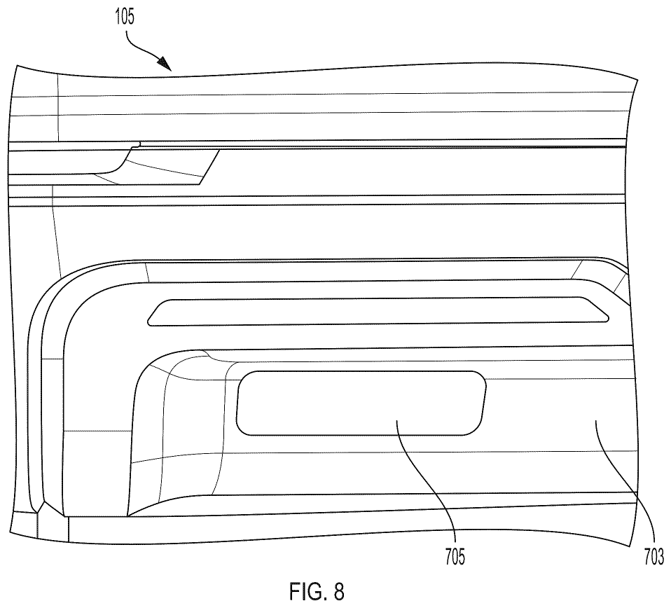

FIG. 8 depicts a perspective view of the vehicle 105. As shown in FIG. 8, the plug 705 can be inserted into the opening 710. FIG. 8 depicts an example of the plug 705 isolating the bumper port 205 from an external environment. The plug 705 can include at least one indicator or identifying element. For example, the plug 705 can include a Light Emitting Diode (LED) that can produce to identify a location of the plug 705 within the portion 703.

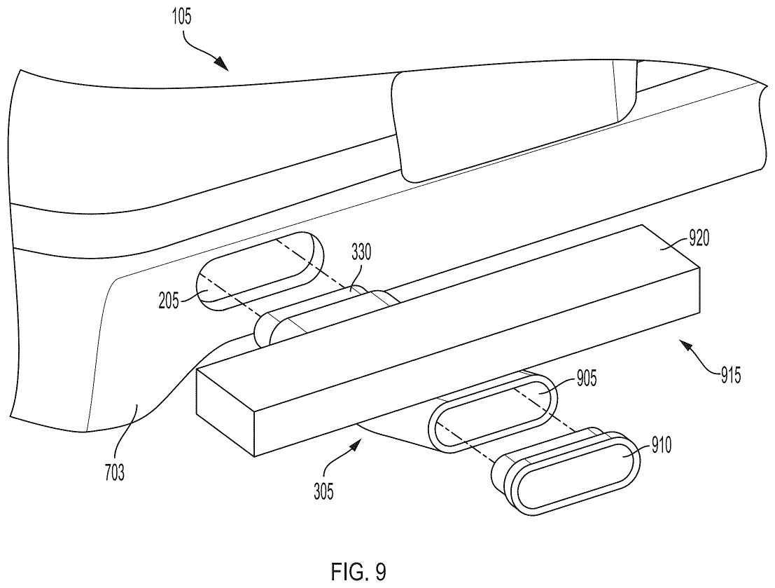

FIG. 9 depicts a perspective view of the vehicle 105. The vehicle 105 can include the bumper port 205. The vehicle 105 can include the attachment mechanism 305. The vehicle 105 can also receive the attachment mechanism 305. For example, the vehicle 105 can receive the attachment mechanism 305 responsive to the portion 330 inserting into the opening 210. The attachment mechanism 305 can include at least one aperture 905. The aperture 905 can be included in the body 310. The apparatus 200 can include at least one cover 910. The cover 910 can be inserted into the aperture 905. The cover 910 can include at least one of a reflective material or a light fixture. The reflective material can reflect light. The light fixture can electrically couple with the vehicle 105 and the light fixture can produce light.

The attachment mechanism 305 can include at least one tray 915. The tray 915 can include at least one the trays described herein. FIG. 9 depicts an example of the tray 915 as a beam. The tray 915 can include a surface 920. The surface 920 can support an object. For example, the surface 920 can support an electric bicycle. The tray 915 can electrically couple the electric bike with a battery of the vehicle 105. For example, the tray 915 can electrically couple the electric bike with the batteries 115.

The attachment mechanism 305 or a component thereof can provide power to at least one device. For example, the attachment mechanism 305 can be electrically coupled with the battery 115 of the vehicle 105. To continue this example, the attachment mechanism 305 can provide power, via the battery 115, to one or more devices. The attachment mechanism 305 can electrically couple with one or more devices to provide power the devices. For example, the attachment mechanism 305 can include a Universal Serial Bus (USB) port and the attachment mechanism 305 can electrically couple with a device responsive to a device being inserted into the USB port. As another example, the attachment mechanism 305 can include a charging pad or a charging surface (e.g., induction charging).

A vehicle can include at least one bumper port 205. For example, the vehicle 105 can include a first bumper port 205 and a second bumper port 205. The first bumper port 205 can receive a first attachment mechanism 305 and the second bumper port 205 can receive a second attachment mechanism 305. The bumper port 205 can be electrically coupled with a power source. For example, the bumper port 205 can be electrically coupled with the battery 115. The bumper port 205 can include electrical contacts, electrical pins, or electrical ports. The bumper port 205 can receive the attachment mechanism 305 to electrically couple the attachment mechanism 305 with the battery 115. For example, the portion 330 can include electrical contacts that interact with, interface with, or otherwise engage with the electrical contracts of the bumper port 205.

The bumper port 205 can be in communication with one or more computing devices. For example, the bumper port 205 can be in communication with an infotainment system of the vehicle 105. As another example, the bumper port 205 can be in communication with a mobile device (e.g., a mobile phone, a tablet, a laptop, a smart watch, etc.). The bumper port 205 can also be in communication with at least one component of the vehicle 105. For example, the bumper port 205 can be in communication with one or more buttons or scroll wheels on a steering wheel. The bumper port 205 can be controllable by at least one of the components or devices that the bumper port 205 is in communication with. For example, a user of the infotainment system of the vehicle 105 can select an icon or a button displayed on a user interface to turn on or turn off power that is provided to the bumper port 205. As another example, the user can select an icon to have power provided to a first bumper port 205 and to have power not be provided to a second bumper port 205.

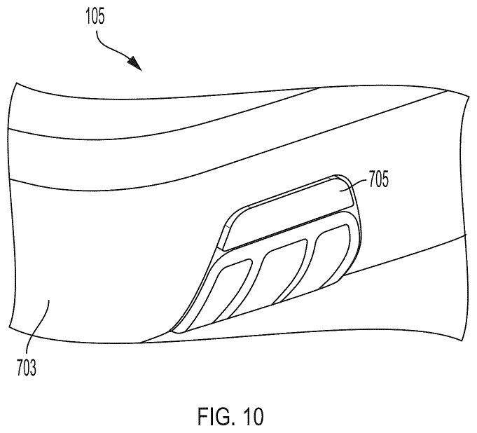

FIG. 10 depicts a perspective view of the vehicle 105. The plug 705 can be included in or otherwise integrated into the vehicle 105. For example, the plug 705 can be coupled with the vehicle 105. As another example, the plug 705 can be provided with the vehicle 105. The plug 705 can be or include a dropdown element or a flap. For example, a force can be applied to plug 705 move to plug to a dropdown position.

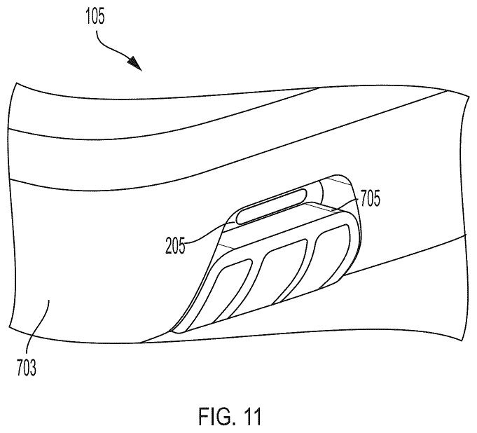

FIG. 11 depicts a perspective view of the vehicle 105. As shown in FIG. 11, the plug 705 has been moved to a dropdown position. The plug 705 can provide access, responsive to moving to the dropdown position, the bumper port 205. The plug 705 can include a resting position. For example, the position of the plug 705, as shown in FIG. 10, can include a resting position. The position of the plug 705, as shown in FIG. 11, can include a spring-loaded position. For example, if force is applied to plug 705 with the plug 705 in the spring-loaded position, the plug 705 can return to the position as shown in FIG. 10.

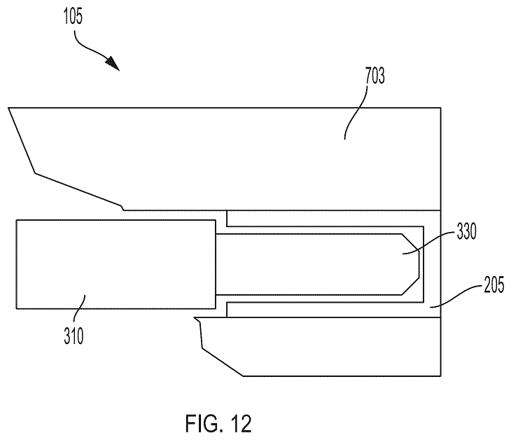

FIG. 12 depicts a cross-sectional view of the vehicle 105. The vehicle 105 can include the bumper port 205. As shown in FIG. 12, a portion of the bumper port 205 has been removed to show an internal portion of the housing 230. The body 310 and the portion 330 can have at least one ratio. For example, the body 310 and the portion 330 can have a one-to-one ratio. A one-to-one ratio can refer to or mean that a size of the body 310 is similar to a size of the portion 330. FIG. 12 depicts an example of the body 310 being larger than the portion 330.

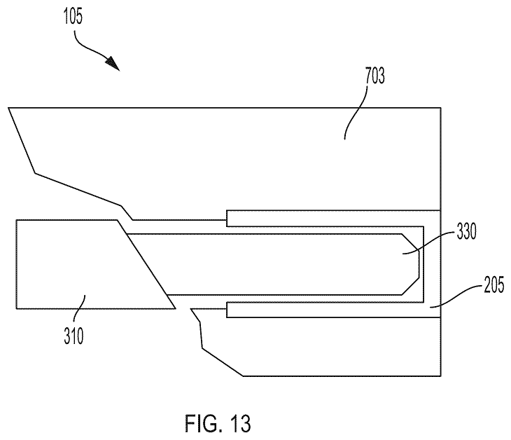

FIG. 13 depicts a cross-sectional view of the vehicle 105. FIG. 13 depicts an example of the body 310 and the portion 330 having a ratio that is different from a one-to-one ratio. For example, the size of the portion 330 is larger than the size of the body 310. Other ratios, such as two-to-one, three-to-one, and four-to-one can be used. The portion 330 can be longer than the body 310. The portion 330 can also be longer than the body 310. The portion 330 can also extend or elongate relative to the body 310.

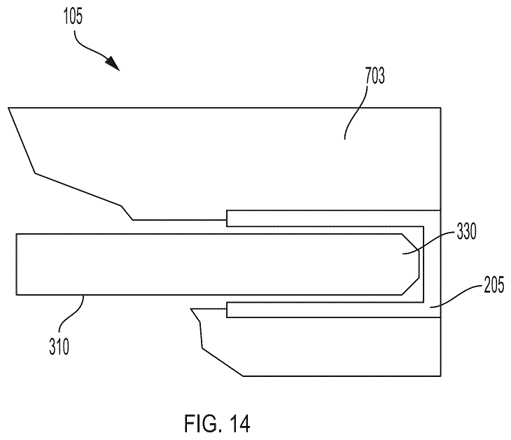

FIG. 14 depicts a cross-sectional view of the vehicle 105. FIG. 14 depicts an example of the portion 330 being included in or otherwise defining the body 310. For example, the body 310 and the portion 330 can be a single component. As another example, the portion 330 can define the body 310. The portion 330 and the body 310 can be a unitary portion. For example, the body 310 can include the portion 330. As another example, the portion 330 can represent the body 310. FIG. 14 also depicts an example of the portion 330 and the body 310 as a one-to-one ratio.

The attachment mechanism 305 and/or one or more components thereof can include a variety of different apparatuses. For example, the attachment mechanism 305 can include at least one of bike racks, coolers, compartments, storage bins, or various types of objects. As another example, the tray 915 can include bike racks that couple with the attachment mechanism 305. The apparatuses can couple with or connect to the bumper port 205 based on the various examples described herein.

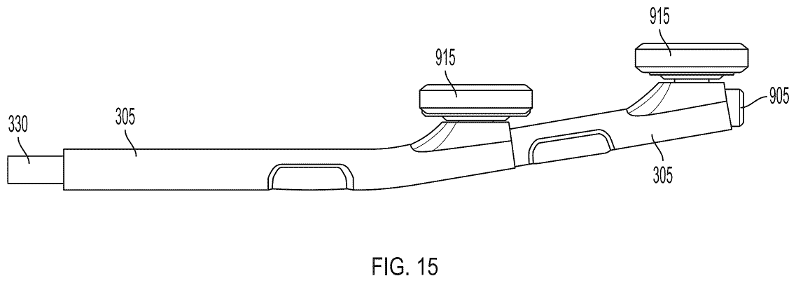

FIG. 15 depicts a perspective view of the attachment mechanism 305. The apparatus 200 can include at least one attachment mechanism 305. For example, the apparatus 200 can include a first attachment mechanism 305 and a second attachment mechanism 305. FIG. 15 depicts an example of a first attachment mechanism 305 and a second attachment mechanism 305. The aperture 905 of the first attachment mechanism 305 can receive the portion 330 of the second attachment mechanism 305. FIG. 15 depicts an example of the first attachment mechanism 305 having, via the aperture 905, receiving the portion 330 of the second attachment mechanism 305. The first attachment mechanism 305 and the second attachment mechanism 305 can include the tray 915. FIG. 15 depicts an example of the trays 915 as pads or platforms.

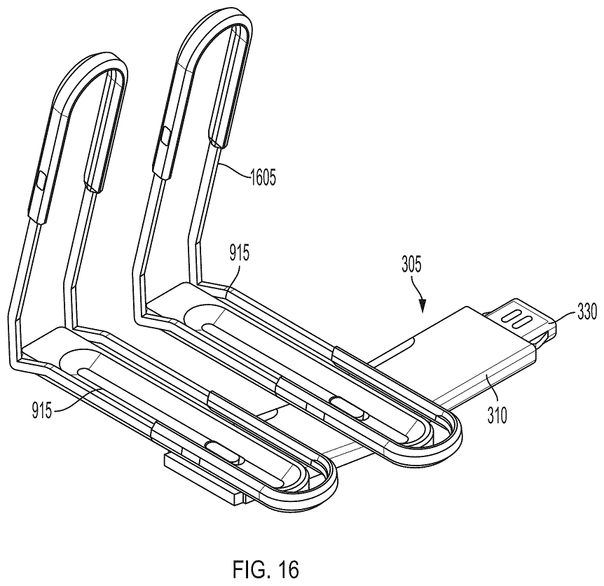

FIG. 16 depicts a perspective view of the attachment mechanism 305. The attachment mechanism 305 can include the trays 915. The trays 915 can also be provided as a separate component to that of the attachment mechanism 305. For example, the trays 915 can couple with or otherwise attach with the attachment mechanism 305. FIG. 16 depicts an example of the trays 915 as bike racks. For example, the trays 915 could each receive or hold at least one tire of an electric or regular bicycle, or other apparatus. The trays 915 can include at least one hoop 1605. The hoop 1605 can receive at least one object. For example, the hoop 1605 can receive a bicycle tire or wheel. The bicycle tire can be inserted into or through an opening defined by the hoop 1605. The hoop 1605 can lock or secure the bicycle tire. For example, the hoop 1605 can compress or ratchet between positions or locations to secure the bicycle tire. As another example, the hoop 1605 can move between setpoints to secure the bicycle tire.

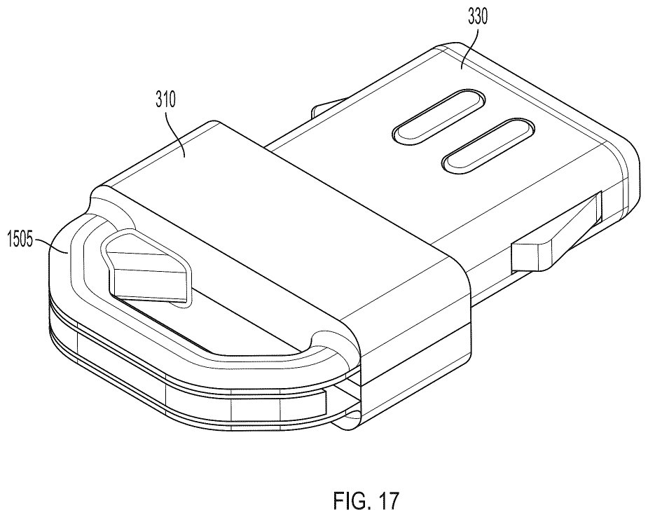

FIG. 17 depicts a perspective view of the attachment mechanism 305. The attachment mechanism 305 can be inserted into the bumper port 205 and an operator of the attachment mechanism 305 can step or otherwise stand on the attachment mechanism. The attachment mechanism 305 can include an opening or a loop to receive or couple with a tow hook (e.g., tow hook accessories, straps, ropes, cables, etc.). For example, the attachment mechanism 305 can refer to or include a took hook or recovery equipment. The attachment mechanism 305 can include at least one handle 1505. The handle 1505 can assist in the insert or the removal of the attachment mechanism 305. For example, an operator of the attachment mechanism 305 can grab or otherwise hold the handle 1505 to insert the attachment mechanism 305 into the bumper port 205.

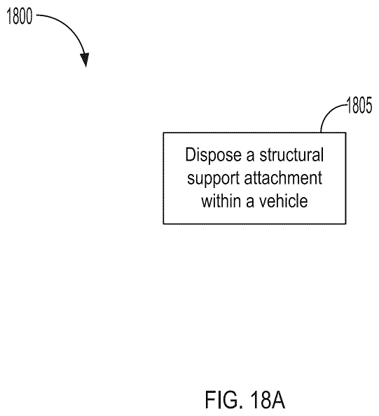

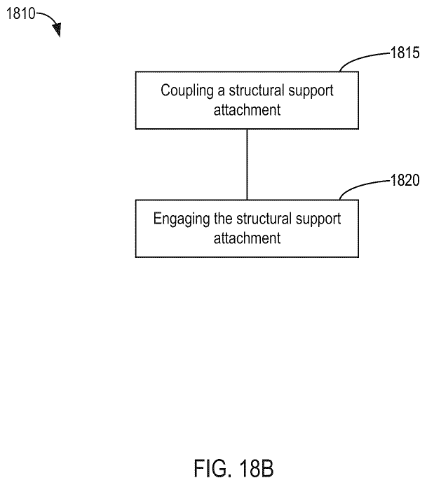

FIG. 18A depicts a block diagram of a process 1800 for manufacturing an apparatus. The apparatus can include the apparatus 200. The apparatus 200 can include the bumper port 205. The manufacturing of the apparatus 200 can include providing the apparatus 200. For example, the apparatus 200 can be provided during assembly of the vehicle 105. The apparatus 200 can also be provided responsive to the apparatus 200 having been purchased.

At act 1805, a structural support attachment can be disposed within a vehicle. For example, the structural support attachment can be disposed within the vehicle 105. The structural support attachment can include the bumper port 205. The bumper port 205 can be disposed within the vehicle 105 by at least one of placing, locating, or otherwise positioning the bumper port 205 or a portion thereof within the vehicle 105. For example, the bumper port 205 can be disposed within the portion 703 of the vehicle 105.

The bumper port 205 can be coupled with the vehicle 105. For example, the bumper port 205 can be coupled with the vehicle 105 responsive to a fastener having been inserted through the slots 220. The bumper port 205 can also be coupled with the vehicle 105 responsive to the bumper port 205 having been disposed within the vehicle 105. The bumper port 205 can engage with a body. For example, the bumper port 205 can engage with the body 310 responsive to the portion 330 having been inserted into the opening 210. The body 310 can include a lever. For example, the body 310 can include the lever 315. The lever 315 can couple the body 310 with the bumper port 205 to support the tray 915. For example, the lever 315 can move from an unlocked position to a locked position and the lever 315 moving to the locked position can cause the protrusions 340 to engage with the housing 230. The body 310 can support the tray 915 external to the vehicle. For example, the body 310 can support the tray 915 external to a body of the vehicle 105.

FIG. 18B depicts a block diagram of a process 1810 for manufacturing an apparatus. The apparatus can be the apparatus 200. The process 1810 can be include the process 1800. The process 1810 can be separate from the process 1800.

At act 1815, a structural support attachment can be coupled. For example, the structural support attachment 205 can be coupled with the vehicle 105. The structural support attachment 205 can be coupled with the vehicle 105 by at least one of attaching, mounting, securing, affixing, or connecting the structural support attachment 205 to the vehicle 105.

At act 1820, the structural support attachment can engage with a body. For example, the structural support attachment 205 can engage with the body 310. The structural support attachment 205 can engage with the body 310 by at least one of receiving, accepting, or holding the body 310. The structural support attachment 205 can engage with the body 310 responsive to insertion of the portion 330 into the opening 210.

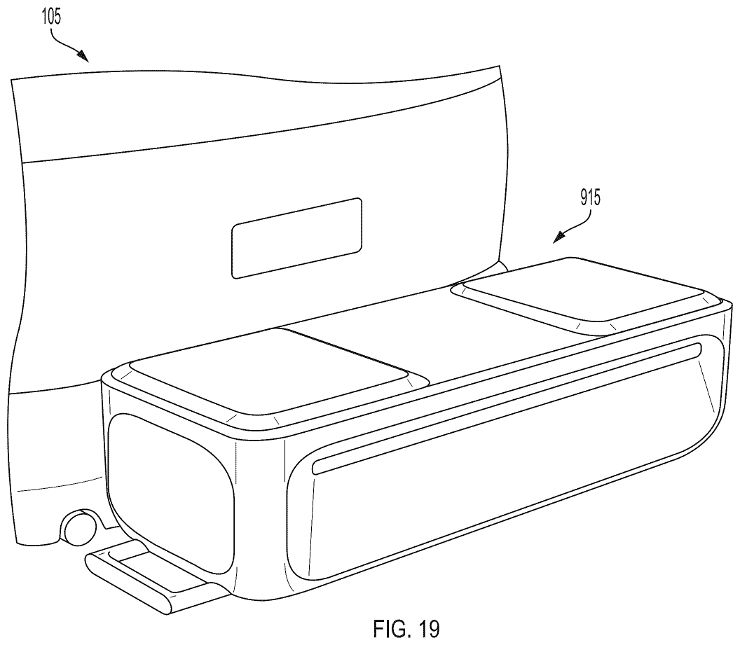

FIG. 19 depicts a perspective view of a vehicle. The vehicle can include the vehicle 105. The vehicle 105 can include the bumper port 205. For example, the vehicle 105 can include a first bumper port 205 and a second bumper port 205. FIG. 19 depicts an example of the bumper port 205 having received the attachment mechanism 305 and an example of the body 310 supporting the tray 915 external to the vehicle 105. FIG. 19 depicts an example of the tray 915 as a storage compartment. The tray 915 can include at least one handle. The tray 915 can include one or more light fixtures. For example, the tray 915 can include light fixtures that can produce light. The tray 915 can be electrically coupled with the battery 115 of the vehicle 105. For example, the bumper port 205 can electrically couple the tray 915 with the battery 115.

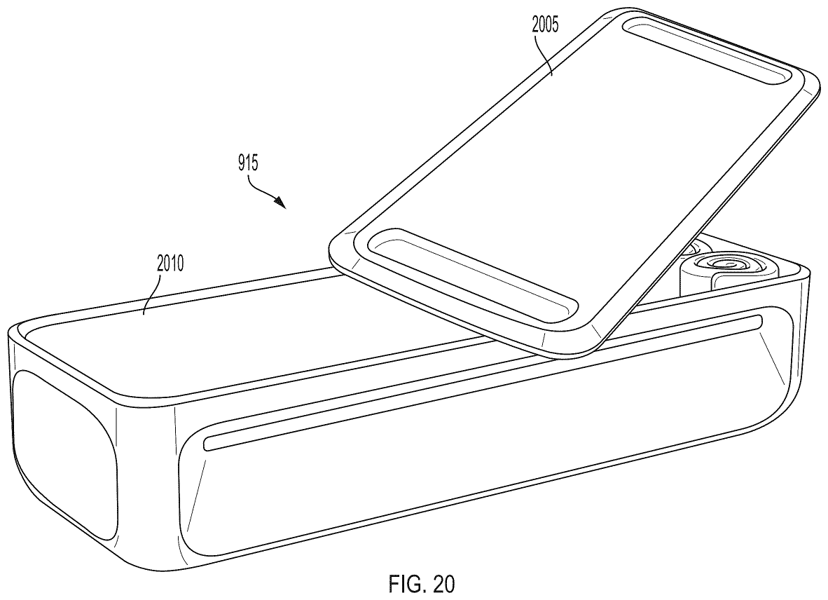

FIG. 20 depicts a perspective view of the tray 915. The tray 915 can include at least one lid 2005 or removable surface 2005. FIG. 20 depicts an example of the tray 915 having the lid 2005 which provides one or more features. For example, the lid 2005 is shown to include a tabletop. As another example, the lid 2005 can also include one or more cup retainers. The lid 2005 can be removably coupled with the tray 915. For example, a user of the tray 915 can interact with, interface with, or otherwise engage with the lid 2005 to remove the lid 2005 from a body of the tray 915. The tray 915 or a body thereof can include a cavity 2010 or other hollow portion 2010. The cavity 2010 can receive, store, or hold at least one item. FIG. 20 depicts an example of the cavity 2010 storing towels. The tray 915 can include at least one compartment. For example, the tray 915 can include a first compartment and a second compartment. The first compartment and the second compartment can be separated or isolated from each other. FIG. 20 depicts an example of a first compartment of the tray 915 as a cooler and a second compartment of the tray 915 as a bin or storage area.

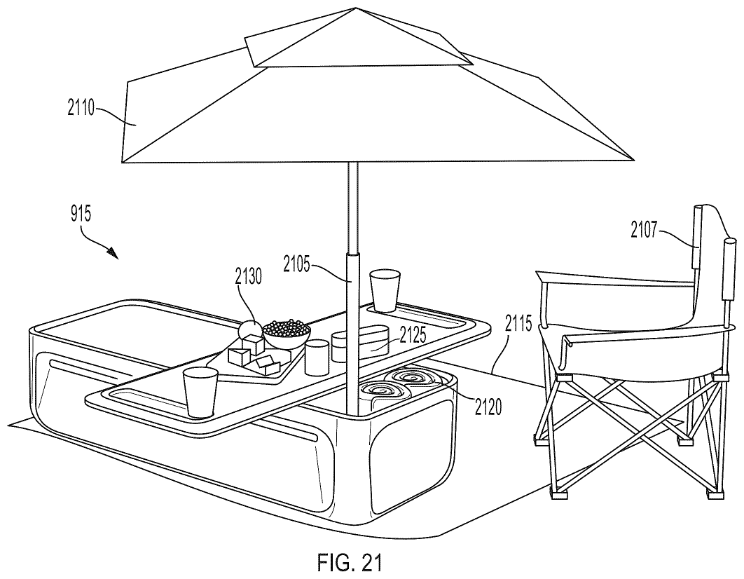

FIG. 21 depicts a perspective view of the tray 915. The tray 915 can include at least one support structure 2105. For example, the tray 915 can receive an object and the support structure 2105 can support the object. FIG. 21 depicts an example of the support structure 2105 supporting an umbrella 2110. The various objects shown in FIG. 21 can be stored or otherwise located inside of the tray 915. For example, the tray 915 can store a chair 2107, an umbrella 2110, a rug 2115, towels 2120, speakers 2125, or food and beverages 2130.

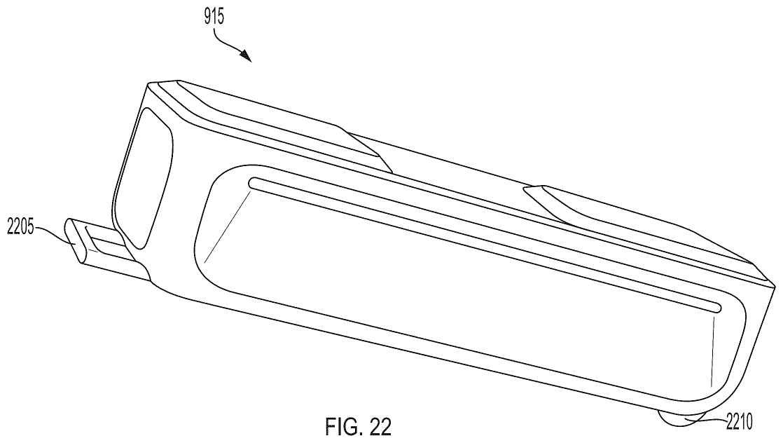

FIG. 22 depicts a perspective view of the tray 915. The tray 915 can include at least one wheel 2210. The wheels 2210 and handle 2205 can be connected or linked. For example, the handle 2205 can move the wheels 2210 from a position within a body of the tray 915 to a position external to the tray 915. The handle 2205 can move the wheels 2210 responsive to the handle 2205 moving from a retracted position to an extended. FIG. 22 depicts an example of the handle 2205 in an extended position and an example of the wheels 2210 in a position external to the tray. The handle 2205 can move the wheels 2210 by at least one of releasing a latch, removing an obstruction, or otherwise freeing the wheels 2210.

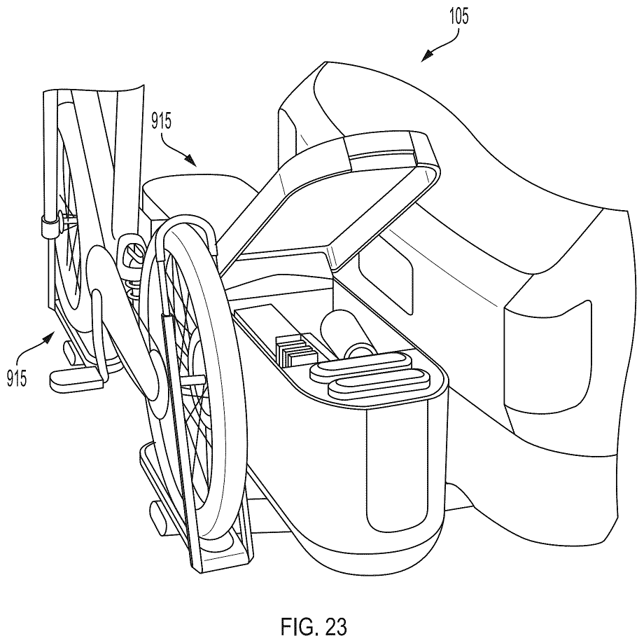

FIG. 23 depicts a perspective view of the vehicle 105. The vehicle 105 can include the bumper port 205. For example, the vehicle 105 can include a first bumper port 205 and a second bumper port 205. The vehicle 105 can include the attachment mechanism 305. The attachment mechanism 305 can include a first tray 915 and a second tray 915. FIG. 23 depicts an example of a first tray 915 as bike rack and an example of a second tray 915 as a storage compartment. The second tray 915 can include one or more components. For example, the second tray 915 can include recreation equipment, hydration material, battery banks for the electric bike, or first aid kit material. The second tray 915 and the first tray 915 can be electrically coupled with one another. For example, the second tray 915 can provide power to the first tray 915. As another example, the first tray 915 and the second tray 915 can receive power from the battery 115.

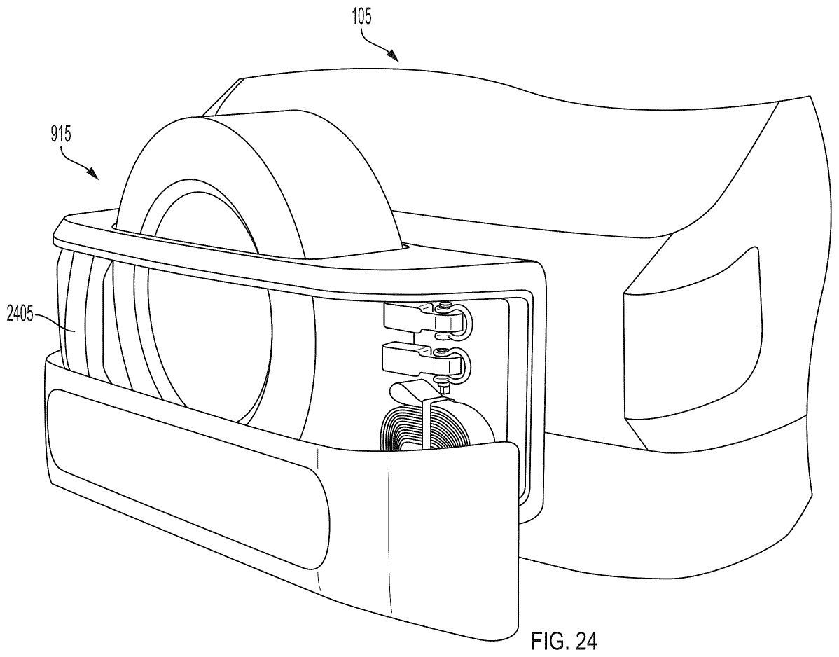

FIG. 24 depicts a perspective view of a vehicle. The vehicle can include the vehicle 105. The vehicle 105 can include the bumper port 205. For example, the vehicle 105 can include a first bumper port 205 and a second bumper port 205. The vehicle 105 can include the attachment mechanism 305. The attachment mechanism 305 can include the tray 915. FIG. 24 depicts an example of the tray 915 as a rally kit. The tray 915 can include a compartment 2405 to store or hold recovery equipment. For example, the tray 915 can store a tire, tow straps, clamps, a shackle, towing equipment, flares, reflectors, flashlight, or other equipment.

The tray 915 can be movable coupled with the attachment mechanism 305. For example, the tray 915 can hinge, pivot, swivel, rotate, detach, or move relative to the attachment mechanism 305. The tray 915 can include at least one position. For example, the tray 915 can include a first position and a second position. The first position can include at least one of a collapsed, retracted, closed, or folded position. The second position can include at least one of an extended, dropped, or lowered position. FIG. 24 depicts an example of the tray 915 in the first position. The tray 915 can include at least one door of movable component. The door can provide access to the equipment stored within the tray 915. For example, the door can slide from a closed position to an open position. To continue this example, the door can provide access to equipment within the tray 915 with the door in the open position. FIG. 24 depicts an example of the door in the open position.

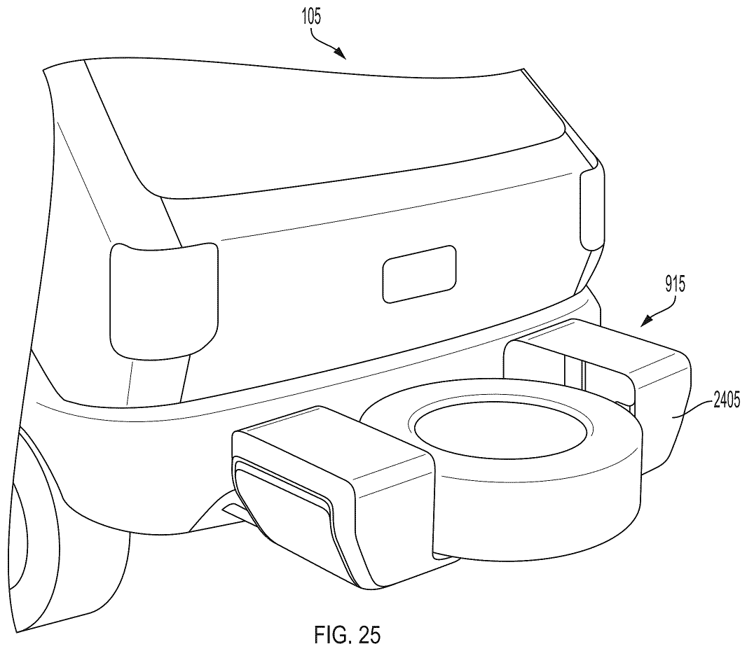

FIG. 25 depicts a perspective view of a vehicle. The vehicle can include the vehicle 105. The vehicle 105 can include the tray 915. FIG. 25 depicts an example of the tray 915 in a dropped position. As shown in FIG. 25, the tray 915 has been moved from the first position (shown in FIG. 24) to a second position. The tire can be accessible with the tray 915 in the second position. The tray 915 can include the compartment 2405. The compartment 2405 can include an opening or a void to house or hold the tire.

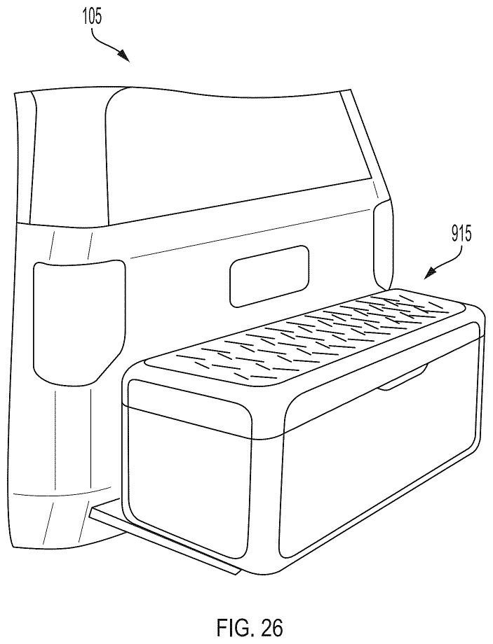

FIG. 26 depicts a perspective view of a vehicle. The vehicle can include the vehicle 105. The vehicle 105 can include the bumper port 205. For example, the vehicle 105 can include a first bumper port 205 and a second bumper port 205. The vehicle 105 can include the attachment mechanism 305. The vehicle 105 can include the tray 915. FIG. 26 depicts an example of the tray 915 as a shelf. The tray 915 can include one or more objects. For example, the tray 915 can include a cooler. The objects of the tray 915 can be provided separate from the tray 915. For example, the tray 915 can include a shelf and the shelf can support a cooler that is provided separate to the tray 915.

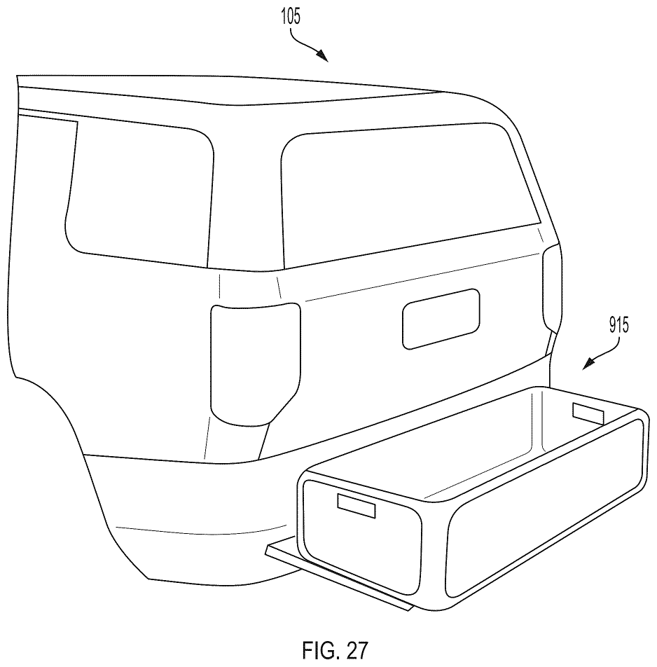

FIG. 27 depicts a perspective view of a vehicle. The vehicle can include the vehicle 105. The vehicle 105 can include the bumper port 205. For example, the vehicle 105 can include a first bumper port 205 and a second bumper port 205. The vehicle 105 can include the attachment mechanism 305. The vehicle 105 can include the tray 915. FIG. 27 depicts an example of the tray 915 as a shelf. The tray 915 can include one or more objects. For example, the tray 915 can include a tote. The objects of the tray 915 can be provided separate from the tray 915. For example, the tote (shown in FIG. 27) can be provided separate from the tray 915.

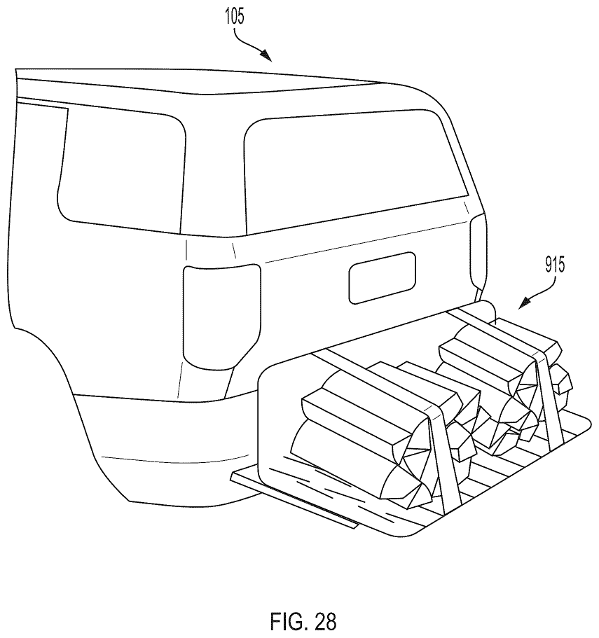

FIG. 28 depicts a perspective view of a vehicle. The vehicle can include the vehicle 105. The vehicle 105 can include the bumper port 205. For example, the vehicle 105 can include a first bumper port 205 and a second bumper port 205. The vehicle 105 can include the attachment mechanism 305. The vehicle 105 can include the tray 915. FIG. 28 depicts an example of the tray 915 a shelf. The tray 915 can include at least one strap. For example, the tray 915 can include a first strap and a second strap. The straps can contact or restrict one or more objects. For example, the straps can secure objects to the shelf. FIG. 28 depicts an example, the straps securing wood to the tray 915.

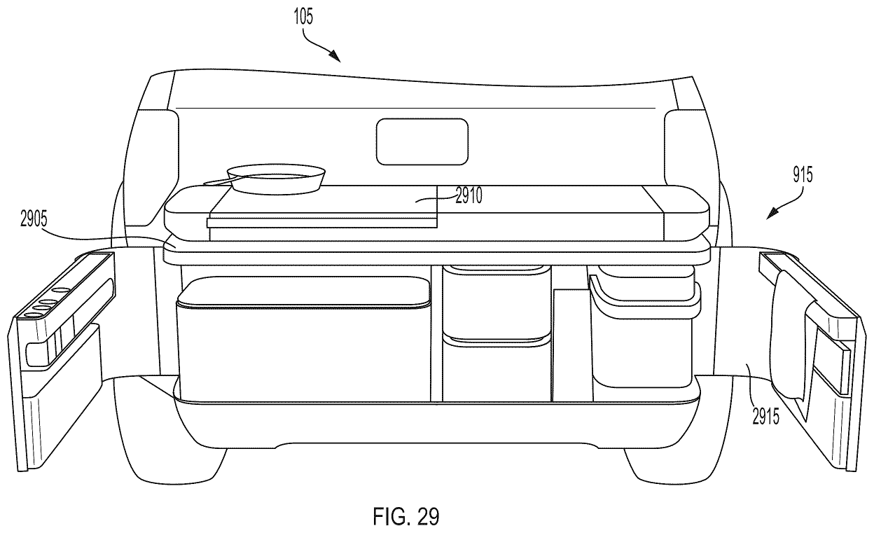

FIG. 29 depicts a perspective view of a vehicle. The vehicle can include the vehicle 105. The vehicle 105 can include the bumper port 205. For example, the vehicle 105 can include a first bumper port 205 and a second bumper port 205. The vehicle 105 can include the attachment mechanism 305. The vehicle 105 can include the tray 915. The tray 915 can support one or more objects. For example, the tray 915 can support a storage compartment. The tray 915 can include one or more objects. For example, the tray 915 can include the storage compartment.

The tray 915 can support one or more objects. For example, the tray 915 can support objects that are in contact with the surface 920. The tray 915 can support objects responsive to the attachment mechanism 305 engaging with the bumper port 205. Stated otherwise, the tray 915 can support objects responsive to the attachment mechanism 305 coupling with the bumper port 205. FIG. 29 depict an example of the tray 915 supporting a compartment 2905. The compartment 2905 can include cooking equipment. As shown in FIG. 29, the compartment 2905 can include a heating element 2910 (e.g., a stove, a range top, a griddle, a cooktop, etc.), prep area, cutting board, cooking utensils, storage areas, a cooler, a trash bin, pots and pans, a water module, equipment organizers, one or more components or equipment. The compartment 2905 can include at least one door 2915. The door 2915 can provide access to the various equipment located within the compartment. The door 2915 can also secure the equipment. The compartment 2905 or the components thereof can receive power from the vehicle 105. For example, the tray 915 can provide power from the battery 115 to the components of the compartment.

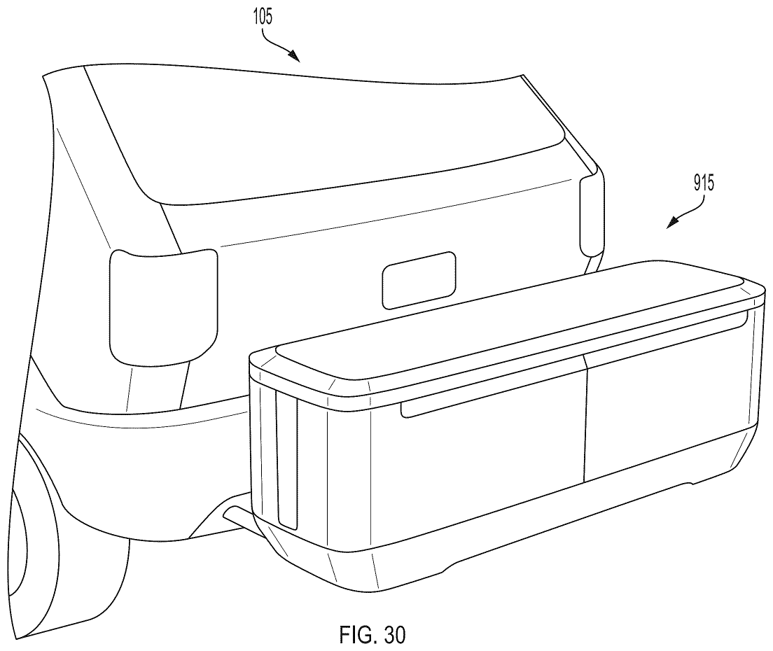

FIG. 30 depicts a perspective view of a vehicle. The vehicle can include the vehicle 105. The vehicle 105 can include the bumper port 205. For example, the vehicle 105 can include a first bumper port 205 and a second bumper port 205. The vehicle 105 can include the attachment mechanism 305. The vehicle 105 can include the tray 915. FIG. 30 depicts an example of the compartment (shown in FIG. 29) without the heating element and the prep area (as shown in FIG. 29). The heating element and the prep area can be removable from the compartment. For example, the heating element can be lifted off or removed from the compartment. The compartment can include an area to store the heating element and the prep area.

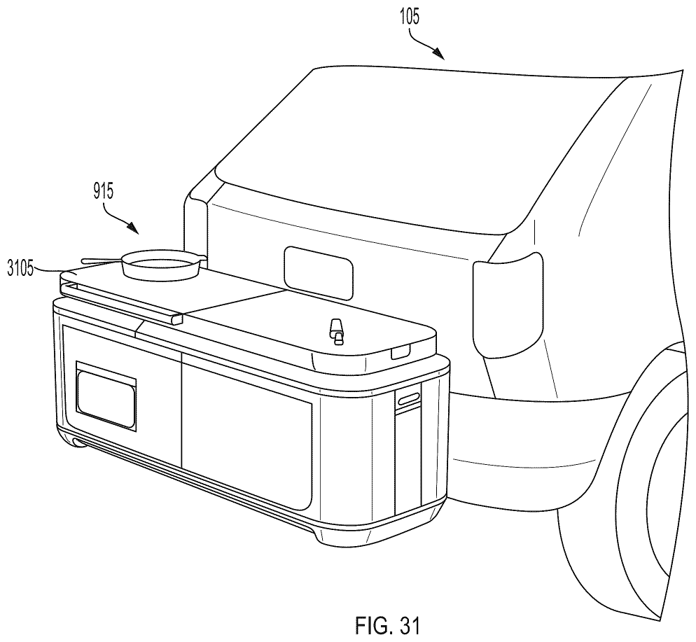

FIG. 31 depicts a perspective view of a vehicle. The vehicle can include the vehicle 105. The vehicle 105 can include the bumper port 205. For example, the vehicle 105 can include a first bumper port 205 and a second bumper port 205. The vehicle 105 can include the attachment mechanism 305. The vehicle 105 can include the tray 915. The tray 915 can support at least one object. For example, the tray 915 can support a cooking apparatus 3105 or a cooking station 3105. The cooking apparatus 3105 can include at least one of the compartments, objects, or components described herein.

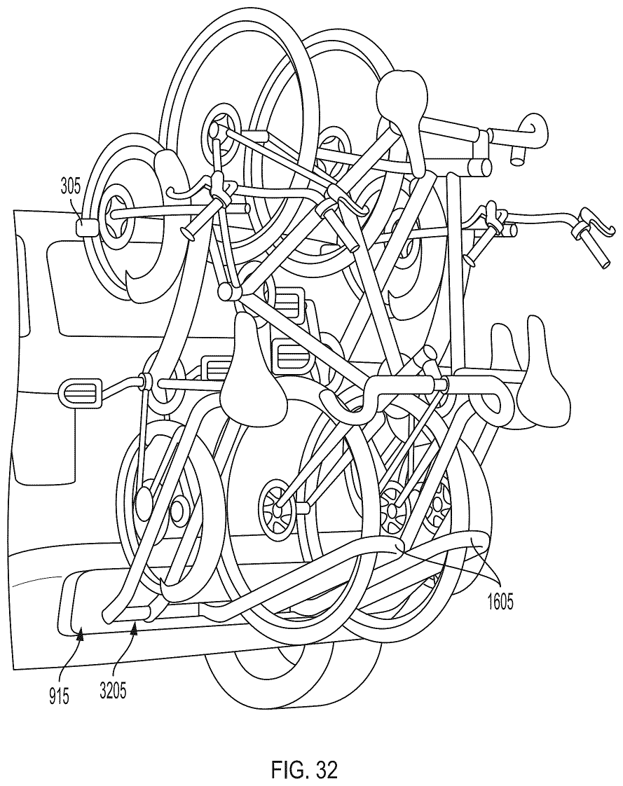

FIG. 32 depicts a perspective view of the vehicle 105. The vehicle 105 can include one or more structural support attachments 205. For example, the vehicle 105 can include a first structural support attachment 205 and a second structural support attachment 205. The first structural support attachment 205 can be disposed within a rear bumper of the vehicle 105. The second structural support attachment 205 can couple with at least a portion of the vehicle 105. For example, the second structural support attachment 205 can couple with a portion of the vehicle 105 that is located superior (e.g., above, higher than, elevated above, etc.) to a rear window of the vehicle 105. The second structural support attachment 205 can receive at least a portion of an object. For example, the second structural support attachment 205 can receive a wheel of a bicycle. As another example, the second structural support attachment 205 can receive a second attachment mechanism 305.

The tray 915 can include one or more hoops 1605. For example, the tray 915 can include a first hoop 1605 and a second hoop 1605. The hoops 1605 can couple with an adjustment mechanism 3205. For example, the hoops 1605 can be attached to or adjoined to the adjustment mechanism 3205. The attachment mechanism 305 can include the adjustment mechanism 3205. The adjustment mechanism 3205 can include at least one of a pivot, a hinge, a rotation point, or a latch. The adjustment mechanism 3205 can move the hoops 1605. For example, the adjustment mechanism 3205 can move the hoops 1605 from a first position to a second position. The adjustment mechanism 3205 can move the hoop 1605 by at least one of rotating, pivoting, swiveling, or adjusting a position of the hoops 1605.

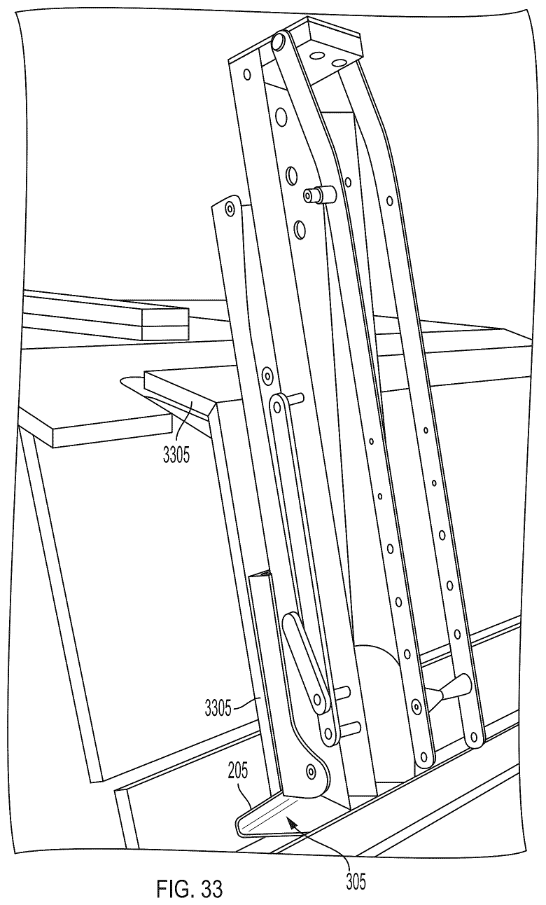

FIG. 33 depicts a perspective view of the vehicle 105. The vehicle 105 can include one or more structural support attachments 205. For example, the vehicle 105 can include a first structural support attachment 205 and a second structural support attachment 205. At least a portion of the structural support attachment 205 can be disposed within a rear gate of the vehicle 105. For example, the vehicle 105 can include a liftgate and at least a portion of the structural support attachment 205 can be disposed within the liftgate. FIG. 33 depicts an example of the structural support attachment 205 having at least a portion disposed within a rear gate of the vehicle 105.

The attachment mechanism 305 can include at least one portion 3305. For example, the attachment mechanism 305 can include a first portion 3305 and a second portion 3305. The portions 3305 can include one or more segments, sections, or structures. The first portion 3305 can couple with the structural support attachment 205. For example, the first portion 3305 can be attached, mounted, secured, or affixed to the structural support attachment 205. The first portion 3305 can couple with a first structural support attachment 205. For example, the first structural support attachment 205 can be disposed within a rear gate of the vehicle 105. To continue this example, the first portion 3305 can couple with the first structural support attachment 205. The second portion 3305 can couple with a second structural support attachment 205. For example, the second portion 3305 can be attached, mounted, secured, or affixed to the second structural support attachment 205. The second structural support attachment 205 can be superior to a rear window of the vehicle. For example, the second structural support attachment 205 can be located above the rear window of the vehicle 105.

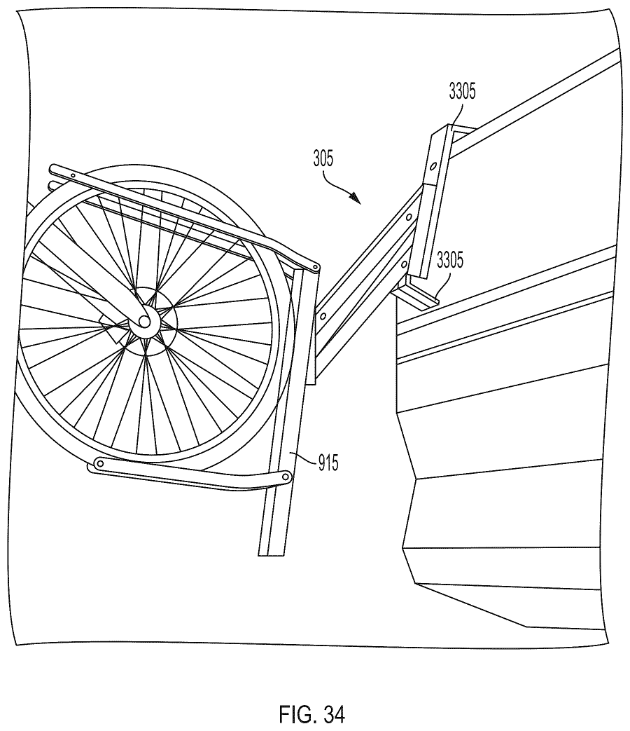

FIG. 34 depicts a perspective view of the vehicle 105. The vehicle 105 can include attachment mechanism 305. The attachment mechanism 305 can include the tray 915. The tray 915 can include one or more positions. For example, the tray 915 can include a first position and a second position. The first position can include a deployed position. The second position can include a stowed position. FIG. 34 depicts an example of the tray 915 in a deployed position. The tray 915 can receive an object with the tray 915 in the first position. For example, the tray 915 can provide or serve as a ramp with the tray 915 in the first position. The tray 915 can stow the object with the tray 915 in the second position. For example, the tray 915 can secure a bicycle to the vehicle 105 with the tray 915 in the stowed position.

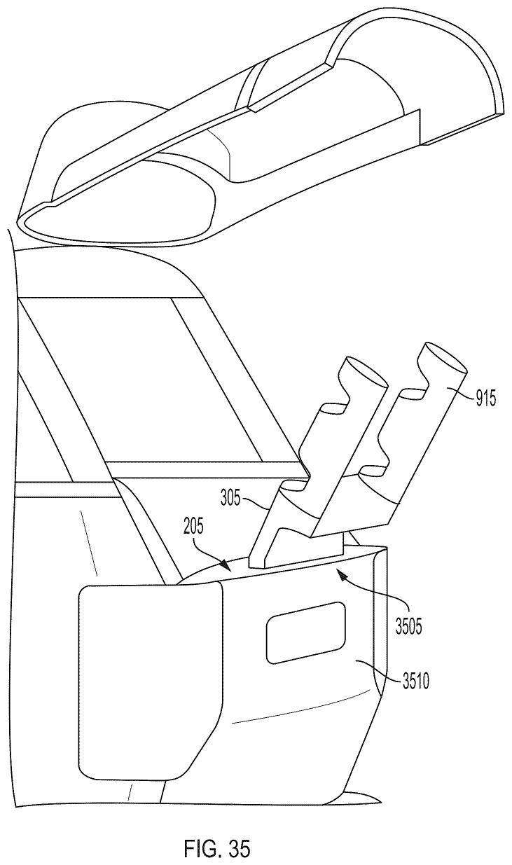

FIG. 35 depicts a perspective view of the vehicle 105. The vehicle 105 can include the structural support attachment 205. The structural support attachment 205 can include the attachment mechanism 305 and the tray 915. For example, the attachment mechanism 305 and the tray 915 can be provided with the structural support attachment 205. The structural support attachment 205 can be disposed within a portion of a rear gate 3510 of the vehicle 105. For example, the structural support attachment 205 can be disposed within a body of a lower portion of a split gate 3510. As another example, the rear gate may include a panel and the structural support attachment 205 can be disposed within the panel.

The apparatus 200 can include at least one adjustment assembly 3505. The adjustment assembly 3505 can be coupled with the structural support attachment 205. The adjustment assembly 3505 can couple the attachment mechanism 305 with the structural support attachment 205. The adjustment assembly 3505 can be disposed within a portion of a rear gate of the vehicle. For example, the adjustment assembly 3505 can be disposed within a panel of a lift gate for the vehicle 105. As another example, the adjustment assembly 3505 can be disposed within a lower portion of a split gate. The adjustment assembly 3505 can move the tray 915. For example, the adjustment assembly 3505 can move the tray 915 from a first position to a second position. The adjustment assembly 3505 can move the tray 915 by at least one of rotating, spinning, swiveling, swinging, adjusting, or otherwise pivoting the tray 915. The adjustment assembly 3505 can move the tray 915 from a first position within a body of the vehicle 105 to a position external to the vehicle 105. FIG. 35 depicts an example of the adjustment assembly 3505 having moved the tray 915 from a position within the body of the vehicle 105 to a position external to the vehicle 105.

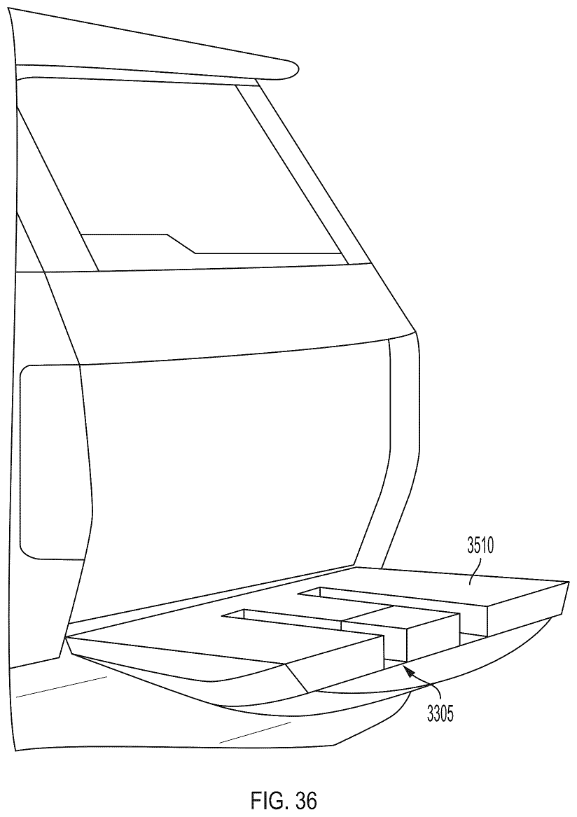

FIG. 36 depicts a perspective view of the vehicle 105. The adjustment assembly 3505 can be locked in one or more positions. For example, the adjustment assembly 3505 can be locked in a position within a body of the vehicle 105. As another example, the adjustment assembly 3505 can be locked in a position external to the vehicle. The adjustment assembly 3505 can be locked in a position within the rear gate 3510 of the vehicle 105. For example, the adjustment assembly 3505 can be locked in a deployed position within a lower portion of a split gate while the lower portion is coupled with an upper portion of the split gate. Stated otherwise, the adjustment assembly 3505 can be prevented from moving within the lower portion of the split gate coupled with the upper portion of the split gate. FIG. 36 depicts an example of the tray 915 stowed within a body of a lower portion of a split gate of the vehicle 105.

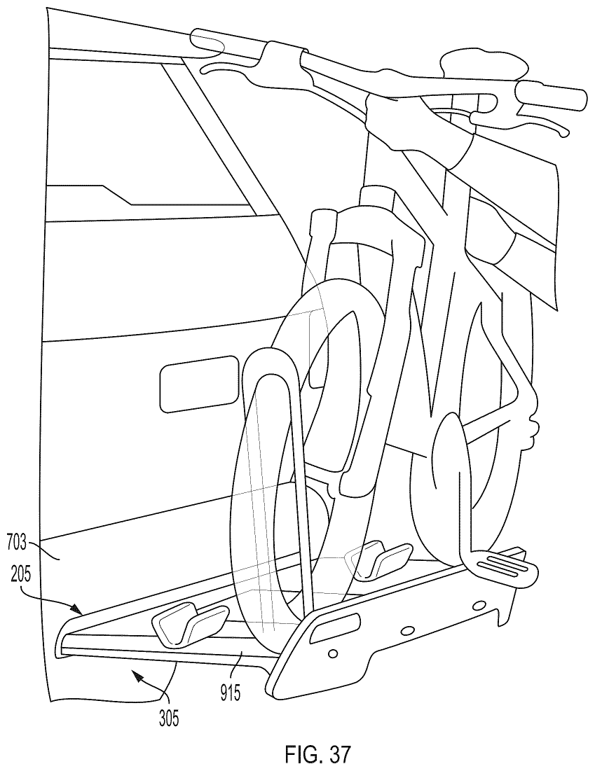

FIG. 37 depicts a perspective view of the vehicle 105. The vehicle 105 can include a rear portion or rear body. For example, the vehicle 105 can include a rear bumper. The rear portion or rear body can include the portion 703. The structural support attachment 205 can be disposed within a rear body of the vehicle 105. For example, the structural support attachment 205 can be disposed within the rear bumper of the vehicle 105. The portion 703 can stow the tray 915. For example, the portion 703 can include a void to receive the tray 915. The portion 703 can stow the tray 915 in a position within the vehicle 105. The portion 703 can deploy the tray 915. For example, the attachment mechanism 305 can deploy the tray 915 from a position within the vehicle 105 to a position external to the vehicle. FIG. 37 depicts an example of the tray 915 deployed in a position external to the vehicle 105.

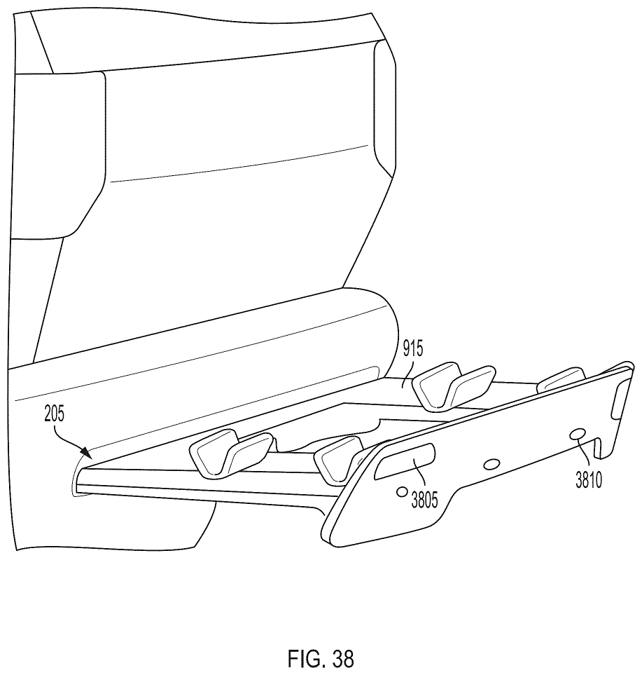

FIG. 38 depicts a perspective view of the vehicle 105. The tray 915 can include at least one light source 3805 and at least one sensor 3810. The light sources 3805 can produce light. For example, the light sources 3805 can emit light. The sensors 3810 can detect one or more objects. For example, the sensors 3810 can include proximity sensors and the sensors 3810 can detect objects proximate to the sensors 3810. The tray 915 can communicate with the vehicle 105. For example, the tray 915 can include a processing circuit and the processing circuit can communicate with a controller of the vehicle 105. The tray 915 can communicate with the vehicle 105 to control the light sources 3805. For example, the tray 915 can communicate with the vehicle 105 to receive control signals. The tray 915 can communicate with the vehicle 105 to control the sensors 3810. For example, the tray 915 can communicate data, collected by the sensors 3810, to the vehicle 105.

The apparatus 200 can include one or more processors. The processors can be in communication with the tray 915. The processors can move the tray 915. For example, the processors can move the tray 915 form a first position to a second position. The processors can move the tray 915 by controlling one or more actuators of the vehicle 105. For example, the actuators can be coupled with the tray 915. To continue this example, at least a portion of the actuators can extend, based on signals from the processors, to deploy the tray 915. The actuators can retract to stow the tray 915 in the vehicle 105.

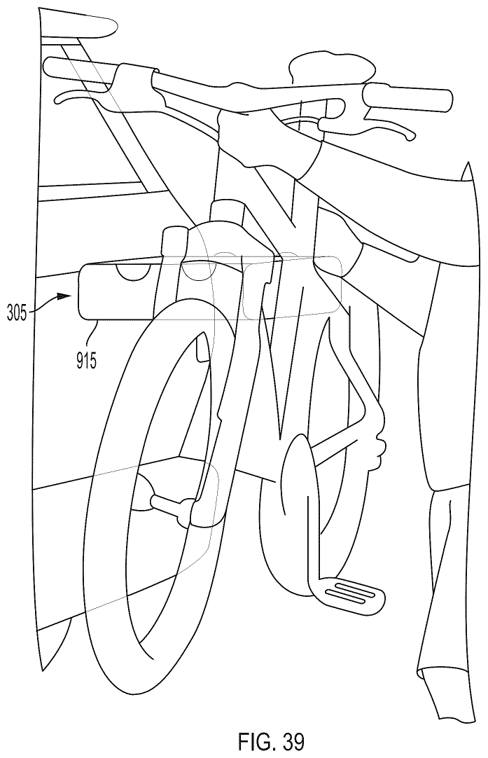

FIG. 39 depicts a perspective view of the vehicle 105. The attachment mechanism 305 can include the tray 915. The tray 915 can include one or more configurations. For example, the tray 915 can include a first configuration and a second configuration. The tray 915 can adjust from the first configuration to the second configuration. For example, the tray 915 can be folded, collapsed, extended, deployed, or stowed to change from the first configuration to the second configuration. The tray 915 can receive an object in a first configuration. For example, the tray 915 can receive a bicycle in a deployed configuration. The tray 915 can be stowed in a second configuration. For example, the tray 915 can be stowed in the vehicle 105 with the tray 915 in a folded or collapsed configuration. FIG. 39 depicts an example of the tray 915 in a deployed configuration.

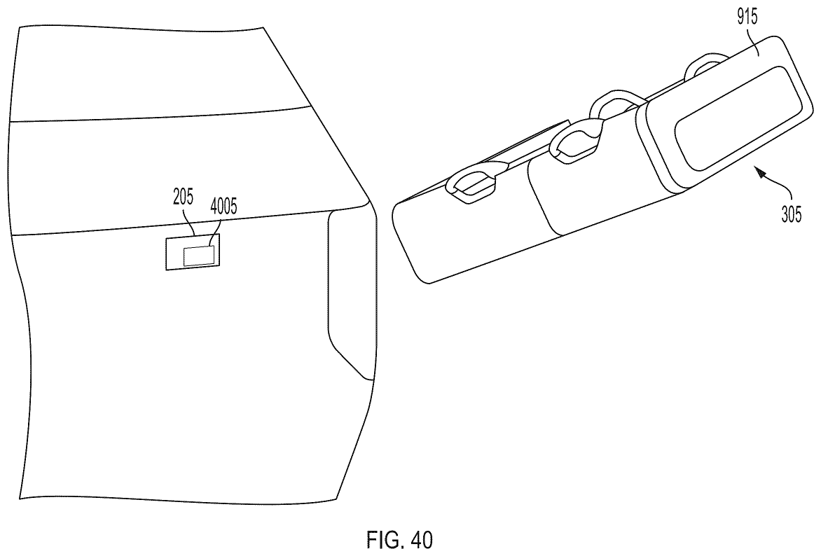

FIG. 40 depicts a perspective view of the vehicle 105. The attachment mechanism 305 can couple with the vehicle 105. For example, the vehicle 105 can include the structural support attachment 205 and the attachment mechanism 305 can couple with the structural support attachment 205. The structural support attachment 205 can include one or more ridges 4005 or slots 4005 and at least portion of the attachment mechanism 305 can be inserted into the ridges 4005 or slots 4005.

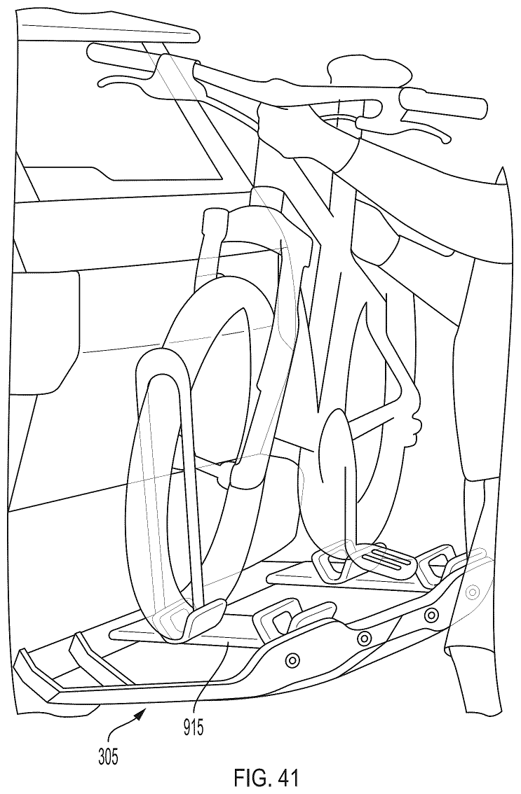

FIG. 41 depicts a perspective view of the vehicle 105. The vehicle 105 can include an undercarriage. For example, the vehicle 105 can include a component or structure that is disposed beneath the rear portion 140. At least a portion of the structural support attachment 205 can be disposed between the undercarriage of the vehicle 105 and a ground surface. For example, the structural support attachment 205 can be positioned between the undercarriage of the vehicle 105 and a ground surface in contact with the vehicle 105. The structural support attachment 205 can move from a first position to a second position. For example, the structural support attachment 205 can move from a position beneath the undercarriage to a position behind the undercarriage. The tray 915 can be stowed within a body of the vehicle 105 with the structural support attachment 205 disposed between the undercarriage and the ground surface. The tray 915 can be deployed to a position external of the vehicle with the structural support attachment 205 positioned behind the undercarriage. FIG. 41 depicts an example of the tray 915 positioned external to the vehicle 105 and an example of the structural support attachment 205 positioned behind the undercarriage of the vehicle 105.

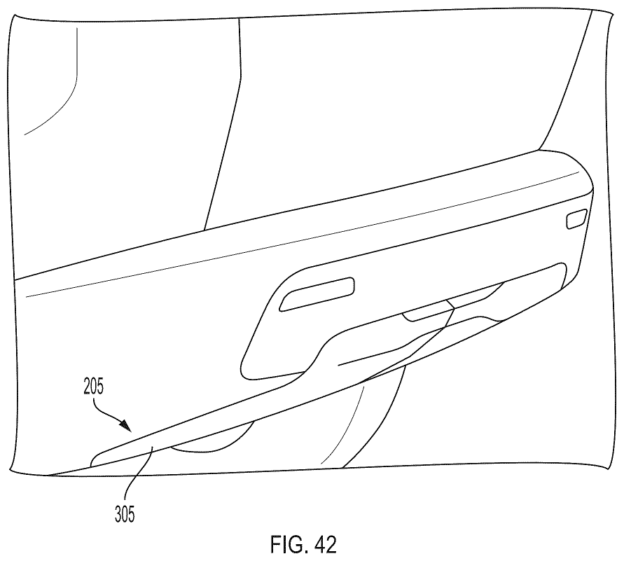

FIG. 42 depicts a perspective view of the vehicle 105. As shown in FIG. 42, the tray 915 has been stowed within a body of the vehicle 105. The tray 915 can move from a position external to the vehicle 105 to a position within the vehicle 105 by at least one of swinging, hinging, pivoting, rotating, or swiveling. The tray 915 can be stowed within the body of the vehicle 105 for transportation. For example, the tray 915 can be stowed within the body of the vehicle 105 when the vehicle 105 is in motion. As another example, the tray 915 can be stowed within the body of the vehicle 105 when the vehicle 105 is parked or idle.

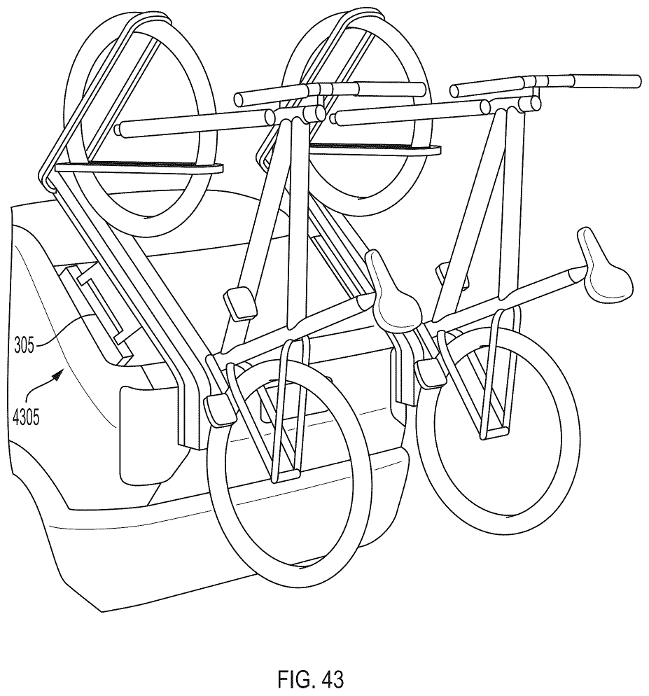

FIG. 43 depicts a perspective view of the vehicle 105. The vehicle 105 can include at least one pillar 4305. The structural support attachment 205 can couple with the pillar 4305. For example, the structural support attachment 205 can be mounted, attached, secured, or affixed to the pillar 4305. The attachment mechanism 305 can couple with the structural support attachment 205 to couple with the vehicle 105. For example, the attachment mechanism 305 can be coupled with the pillar 4305 via the structural support attachment 205. The attachment mechanism 305 can move from a first position to a second position. For example, the attachment mechanism 305 can move from a position at least partially behind the vehicle 105 to a position at least partially lateral to the vehicle 105. The attachment mechanism 305 can hold the tray 915 in one or more positions. For example, the attachment mechanism 305 can hold the tray 915 with the attachment mechanism 305 at least partially behind vehicle 105. As another example, the attachment mechanism 305 can hold the tray 915 with the attachment mechanism 305 at least partially lateral to the vehicle 105.

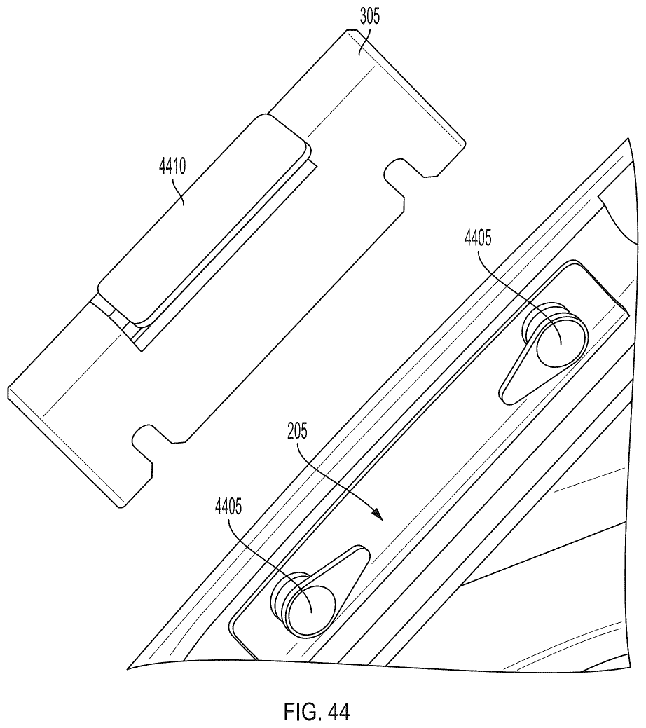

FIG. 44 depicts a perspective view of the vehicle 105. The structural support attachment 205 can include at least one mounting assembly 4405. The attachment mechanism 305 can couple with the mounting assembly 4405. The mounting assembly 4405 can couple the attachment mechanism 305 with the vehicle 105. The attachment mechanism 305 can include at least one platform assembly 4410. The tray 915 can couple with the vehicle 105 via the platform assembly 4410. The platform assembly 4410 can rotate, spin, swivel, adjust, or move relative to a portion of the structural support attachment 205 or the pillar 4305.

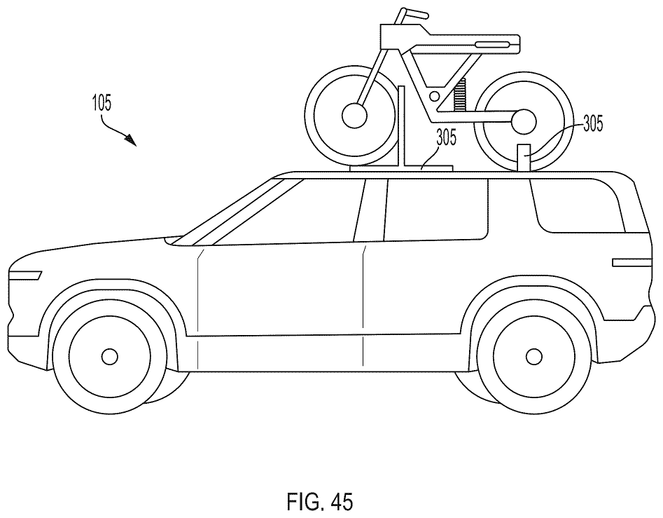

FIG. 45 depicts a perspective view of the vehicle 105. The vehicle 105 can include the attachment mechanism 305. The attachment mechanism 305 can be coupled with a top portion of the vehicle 105. For example, the attachment mechanism 305 can be coupled with a roof of the vehicle 105. As another example, the attachment mechanism 305 can be coupled with a crossbar of the vehicle 105. The bumper port 205 can be disposed or located within the top portion of the vehicle 105. For example, the bumper port 205 can be located within the roof of the vehicle 105. The bumper port 205 can couple the attachment mechanism 305 with the vehicle 105. For example, the bumper port 205 can receive the attachment mechanism 305. To continue this example, the bumper port 205 can secure the attachment mechanism 305 with the vehicle 105 with the attachment mechanism 305 inserted into the bumper port 205.

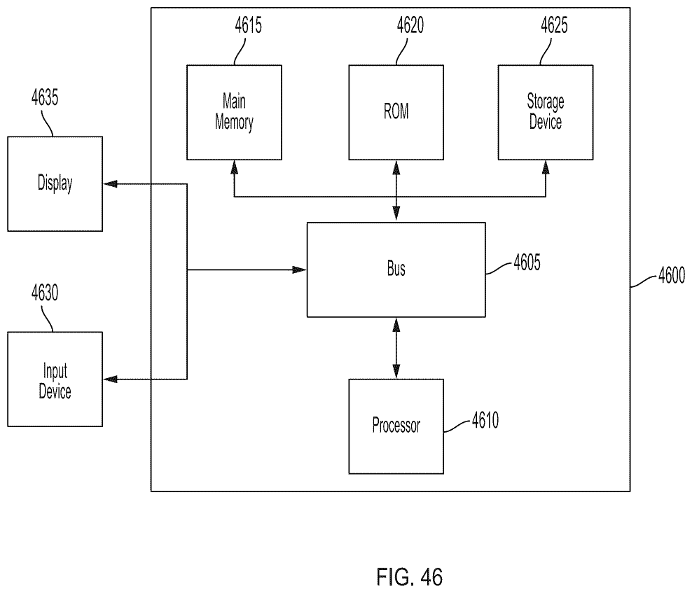

FIG. 46 depicts an example block diagram of an example computer system 4600. The computer system or computing device 4600 can include or be used to implement a data processing system or its components. The computing system 4600 includes at least one bus 4605 or other communication component for communicating information and at least one processor 4610 or processing circuit coupled to the bus 4605 for processing information. The computing system 4600 can also include one or more processors 4610 or processing circuits coupled to the bus for processing information. The computing system 4600 also includes at least one main memory 4615, such as a random access memory (RAM) or other dynamic storage device, coupled to the bus 4605 for storing information, and instructions to be executed by the processor 4610. The main memory 4615 can be used for storing information during execution of instructions by the processor 4610. The computing system 4600 may further include at least one read only memory (ROM) 4620 or other static storage device coupled to the bus 4605 for storing static information and instructions for the processor 4610. A storage device 4625, such as a solid state device, magnetic disk or optical disk, can be coupled to the bus 4605 to persistently store information and instructions.

The computing system 4600 may be coupled via the bus 4605 to a display 4635, such as a liquid crystal display, or active matrix display, for displaying information to a user such as a driver of the electric vehicle 105 or other end user. An input device 4630, such as a keyboard or voice interface may be coupled to the bus 4605 for communicating information and commands to the processor 4610. The input device 4630 can include a touch screen display 4635. The input device 4630 can also include a cursor control, such as a mouse, a trackball, or cursor direction keys, for communicating direction information and command selections to the processor 4610 and for controlling cursor movement on the display 4635.

The processes, systems and methods described herein can be implemented by the computing system 4600 in response to the processor 4610 executing an arrangement of instructions contained in main memory 4615. Such instructions can be read into main memory 4615 from another computer-readable medium, such as the storage device 4625. Execution of the arrangement of instructions contained in main memory 4615 causes the computing system 4600 to perform the illustrative processes described herein. One or more processors in a multi-processing arrangement may also be employed to execute the instructions contained in main memory 4615. Hard-wired circuitry can be used in place of or in combination with software instructions together with the systems and methods described herein. Systems and methods described herein are not limited to any specific combination of hardware circuitry and software.

Although an example computing system has been described in FIG. 46, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a structural support attachment configured to couple with a vehicle; and
the structural support attachment configured to engage with a body, the body including a lever to couple the body with the structural support attachment to support a tray external to the vehicle.

2. The apparatus of claim 1, comprising:
a second structural support attachment to couple with at least a portion of the vehicle located superior to a rear window of the vehicle; and
the second structural support attachment to receive at least a portion of an object.

3. The apparatus of claim 1, comprising:
the tray including a hoop to receive at least a portion of an object; and
the hoop to couple with an adjustment mechanism, the adjustment mechanism configured to move the hoop from a first position to a second position.

4. The apparatus of claim 1, comprising:
at least a portion of the structural support attachment to dispose within a portion of a rear gate of the vehicle.

5. The apparatus of claim 1, comprising:
the body including:
a first portion to couple with the structural support attachment; and
a second portion to couple with a second structural support attachment, the second structural support attachment disposed superior to a rear window of the vehicle.

6. The apparatus of claim 1, comprising:
the tray configured to move from a first position to a second position;
the first position to receive an object; and
the second position to stow the object.

7. The apparatus of claim 1, comprising:
the structural support attachment including the body and the tray; and
the structural support attachment to dispose within a portion of a rear gate of the vehicle.

8. The apparatus of claim 1, comprising:
an adjustment assembly to dispose within a portion of a rear gate of the vehicle; and
the adjustment assembly configured to move the tray from a first position within a body of the vehicle to a second position external to the body of the vehicle.

9. The apparatus of claim 1, comprising:
the tray configured to couple with an adjustment assembly; and
the adjustment assembly configured to lock in a first position with a rear gate of the vehicle in a first position.

10. The apparatus of claim 1, comprising:
the structural support attachment to dispose within a rear body of the vehicle; and
the rear body configured to stow the tray in a first position within the vehicle and deploy the tray to a second position external to the vehicle.

11. The apparatus of claim 1, comprising:
the tray including a light source configured to produce light; and
the tray configured to communicate with the vehicle to control the light source.

12. The apparatus of claim 1, comprising:
the tray including one or more sensors to detect an object; and
the tray configured to communicate with the vehicle to control the one or more sensors.

13. The apparatus of claim 1, comprising:
at least one processor in communication with the tray; and
the at least one processor configured to move the tray from a first position to a second position.

14. The apparatus of claim 1, comprising:
the body including the tray;
the tray configured to adjust from a first configuration to a second configuration;
the first configuration to receive an object; and
the second configuration to stow the tray.

15. The apparatus of claim 1, comprising:
at least a portion of the structural support attachment to dispose between an undercarriage of the vehicle and a ground surface;
the structural support attachment to move from a first position to a second position;
the tray stowed within a body of the vehicle with the structural support attachment in the first position; and
the tray deployed to a position external of the vehicle with the structural support attachment in the second position.

16. The apparatus of claim 1, comprising:
the structural support attachment to couple with a rear pillar of the vehicle.

17. The apparatus of claim 16, comprising:
an attachment mechanism including the body, the attachment mechanism configured to move from a first position to a second position; and
the attachment mechanism configured to hold the tray while in the first position or the second position.

18. A vehicle, comprising:
a structural support attachment configured to couple with the vehicle; and
the structural support attachment configured to engage with a body, the body including a lever to couple the body with the structural support attachment to support a tray external to the vehicle.

19. The vehicle of claim 18, comprising:
the structural support attachment disposed within a first opening of the vehicle;
the structural support attachment configured to support a first portion of the tray;
a second structural support attachment configured to dispose within a second opening of the vehicle; and
the second structural support attachment configured to support a second portion of the tray.

20. The vehicle of claim 18, comprising:
the structural support attachment disposed within a top portion of the vehicle; and
an attachment mechanism including the body, the attachment mechanism configured to couple with the top portion of the vehicle via the structural support attachment.

21. A method, comprising:
disposing a structural support attachment within a portion of a vehicle;
the structural support attachment configured to couple with the vehicle; and
the structural support attachment configured to engage with a body, the body including a lever to couple the body with the structural support attachment to support a tray external to the vehicle.
